(19) United States
(12) Patent Application Publication
(10) Pub. No.: US 2025/0060413 A1
(43) Pub. Date: Feb. 20, 2025

(54) METHOD FOR ESTIMATING STATE OF POWER BASED ON ELECTROCHEMICAL MODEL OF LITHIUM-ION BATTERY

(71) Applicant: TSINGHUA UNIVERSITY, Beijing (CN)

(72) Inventors: Qixin CHEN, Beijing (CN); Yuanbo CHEN, Beijing (CN); Yuxuan GU, Beijing (CN); Hongye GUO, Beijing (CN); Kedi ZHENG, Beijing (CN); Ruike LYU, Beijing (CN)

(21) Appl. No.: 18/919,593

(22) Filed: Oct. 18, 2024

Related U.S. Application Data
(63) Continuation of application No. PCT/CN2022/092570, filed on May 12, 2022.

(30) Foreign Application Priority Data
Apr. 22, 2022 (CN) 202210432340.6

(51) Int. Cl. G01R 31/367; G01R 31/374; G01R 31/378; G01R 31/388

(52) U.S. Cl. CPC G01R 31/367; G01R 31/374; G01R 31/378; G01R 31/388

(57) ABSTRACT

A method for estimating a state of power based on an electrochemical model of a lithium-ion battery includes: obtaining an ambient temperature and an initial state of charge of the battery; obtaining a simulation result of the battery at each moment within a preset time period based on the state information about the battery and the electrochemical model of the battery; performing simulation by taking the maximum feasible current value as an amplitude of an input constant current sequence of a battery port to obtain a curve of a port voltage of the battery within the preset time period; and adjusting the ambient temperature and the initial state of charge, and repeating above steps to obtain the maximum available power values corresponding to different ambient temperatures and different initial states of charge to obtain the state of power of the battery.

### CROSS-REFERENCE TO RELATED APPLICATIONS

This application is a Continuation Application of International Application PCT/CN2022/092570, filed May 12, 2022, which claims priority to Chinese Patent Application No. 202210432340.6, filed on Apr. 22, 2022, the entire disclosures of which are hereby incorporated herein by reference.

### FIELD

The present disclosure relates to the field of estimation technology of a state of power of a lithium-ion battery, and particularly to a method and a device for estimating a state of power based on an electrochemical model of the lithium-ion battery, a non-transitory computer readable storage medium, an electronic device, a computer program product and a computer program.

### BACKGROUND

In recent years, the lithium-ion battery has been widely used as an energy storage medium in a scenario such as an electric vehicle or the power system. In order to meet economic, efficient and safe operation requirements of the lithium-ion battery, accurate and objective depiction of a state of power of the lithium-ion battery needs to be established, so that it has a capability of describing available power output of the lithium-ion battery, and a scientific and efficient energy management strategy for the practical applications of the lithium-ion battery is provided based on the state of power. In a problem of estimating the state of power of the lithium-ion battery, considerations need to be given to not only a safe operation region provided by a battery manufacturer, but also to a potential aging trend and heating of the lithium-ion battery.

Currently, a research for estimating the state of power of the lithium-ion battery mainly focuses on a short-term state of power. In a practical application, the short-term state of power based on an equivalent circuit model is the most extensive. Scholars from the University of Colorado apply a Taylor expansion form of an open-circuit voltage of the lithium-ion battery to a static Rint equivalent circuit model, first considering a state-of-charge constraint and a current constraint to obtain the state of power. Scholars from the University of Technology of Aachen use current-controlled resistance in the equivalent circuit model to improve the accuracy of the equivalent circuit model in estimation of the state of power. However, the equivalent circuit model essentially uses macroscopic resistance and capacitor element to fit an external characteristic of a battery, which may not reflect an actual chemical reaction state and a parameter inside the battery. Therefore, the use of the equivalent circuit model in the estimation of the state of power has the following problems: (1) it is difficult to accurately describe the feasible output of the battery via an internal state constraint; (2) only macro-variables in a short period of time are concerned, and variables that have significant effects in a long period of time such as efficiency, aging and heating are ignored; (3) mismatching of a sampling frequency exists in the estimation of the state of power in the short period of time and an application scene in the long period of time.

### SUMMARY

Embodiments of a first aspect of the present disclosure provide a method for estimating a state of power based on an electrochemical model of a lithium-ion battery, including: S1: obtaining an ambient temperature and an initial state of charge of the battery; S2: obtaining state information about the battery, and obtaining a simulation result of the battery at each moment within a preset time period based on the state information about the battery and the electrochemical model of the lithium-ion battery; S3: obtaining a maximum feasible current value of the battery within the preset time period by iteratively optimizing a simulation process in step S2 with the simulation result of the battery as constraints; S4: performing simulation by taking the maximum feasible current value as an amplitude of an input constant current sequence of a battery port to obtain a curve of a port voltage of the battery within the preset time period, obtaining maximum output power of the battery based on the curve of the port voltage of the battery and the amplitude of the constant current sequence, and taking the maximum output power of the battery as a maximum available power value corresponding to the ambient temperature and the initial state of charge of the battery; and S5: adjusting the ambient temperature and the initial state of charge of the battery, and repeating steps S1-S4 to obtain the maximum available power values corresponding to different ambient temperatures and different initial states of charge of the battery to obtain the state of power of the lithium-ion battery.

Embodiments of a second aspect of the present disclosure provide a non-transitory computer readable storage medium having stored thereon instructions, in which when executed by a processor, the instructions are configured to implement the method for estimating the state of power based on the electrochemical model of the lithium-ion battery as described in any one of embodiments of the first aspect.

Embodiments of a third aspect of the present disclosure provide an electronic device, including a memory, a processor, and a computer program stored in the memory and executable on the processor, in which when executing the computer program, the processor is configured to implement the method for estimating the state of power based on the electrochemical model of the lithium-ion battery as described in any one of embodiments of the first aspect.

Embodiments of a fourth aspect of the present disclosure provide a computer program product, including a computer program code, in which when running on a computer, the computer program code is configured to implement the method for estimating the state of power based on the electrochemical model of the lithium-ion battery as described in any one of embodiments of the first aspect.

Embodiments of a fifth aspect of the present disclosure provide a computer program, including a computer program code, in which when the computer program code runs on a computer, the computer is configured to implement the method for estimating the state of power based on the electrochemical model of the lithium-ion battery as described in any one of embodiments of the first aspect.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions of embodiments made with reference to the drawings, in which:

FIG. 1 is a flow chart illustrating a method for estimating a state of power based on an electrochemical model of a lithium-ion battery provided in an embodiment of the present disclosure;

FIG. 2 is a schematic structural diagram illustrating a lithium-ion battery cell based on a method for estimating a state of power based on an electrochemical model of a lithium-ion battery in embodiments of the present disclosure;

FIG. 3 is another flow chart illustrating a method for estimating a state of power based on an electrochemical model of a lithium-ion battery in embodiments of the present disclosure;

FIG. 4 is a schematic block diagram illustrating a device for estimating a state of power based on an electrochemical model of a lithium-ion battery provided in an embodiment of the present disclosure.

### DETAILED DESCRIPTION

Embodiments of the present disclosure will be described in detail and examples of embodiments are illustrated in the drawings. The same or similar elements and the elements having the same or similar functions are denoted by the same or similar reference numerals throughout the descriptions. Embodiments described herein with reference to drawings are explanatory, serve to explain the present disclosure, and are not construed to limit the present disclosure.

The related research on a method for estimating a state of power of a lithium-ion battery is mainly based on an equivalent circuit. Problems thereof are that an actual internal state constraint of the battery may not be described, cumulative variables that have a significant impact over a long period of time are ignored, and mismatch of a sampling frequency between simulation and application scenes causes some variable constraints to be approximately ignored. In view of the above problems, an electrochemical model of the lithium-ion battery may provide a more accurate, safer and more effective state of power. However, since the electrochemical model is characterized as a nonlinear high-order differential equation of state and has high solving complexity, the researches on the obtaining of the state of power using the electrochemical model are limited, while existing research on the internal constraints is not comprehensive as well. The applicability of such scene is limited, and the advantage of the electrochemical model is not obvious. Therefore, the method for estimating the state of power based on the electrochemical model of the lithium-ion battery needs to fully reflect the internal state constraint of the battery, and further needs to consider the applicability of the scene with lower computational complexity.

With the method for estimating the state of power based on the electrochemical model of the lithium-ion battery provided by embodiments of the present disclosure, the internal state constraint of the battery is constructed via the electrochemical model, and the cumulative effect of some states over the long period of time is considered, so that the state of power of the lithium-ion battery under different states of charge and ambient temperature is estimated based on the electrochemical model, and safe and efficient energy management operation capability of the lithium-ion battery under different power output scenarios is enhanced.

The related art of the present disclosure includes: construction and simulation technology of the electrochemical model of the lithium-ion battery and nonlinear convex optimization solving technology. The electrochemical model of the lithium-ion battery consists of a set of nonlinear high-order differential equations of state, which provides more accurate internal state information and external characteristic information by accurately describing an internal chemical reaction of the battery. The nonlinear convex optimization solving technology is to obtain a decision variable that satisfies nonlinear constraints and enables a nonlinear objective function to be optimal through an optimization solving method. Common optimization solving methods include an interior point method, which describes a convex set through a penalty function and obtains an optimal solution by traversing an internal feasible region.

The present disclosure aims to solve, at least to a certain extent, one of the technical problems in the related art.

Therefore, a first object of the present disclosure is to propose a method for estimating a state of power based on an electrochemical model of a lithium-ion battery, which solves a problem that it is difficult to accurately estimate the state of power of the lithium-ion battery. It can more comprehensively reflect the influence of an internal state constraint of the battery on the feasible power output, completely retains the operation characteristic of the lithium-ion battery under different sampling frequencies in a long period of time and a short period of time. It achieves a purpose of more accurately and effectively estimating a current feasible output power of the battery according to an operation state of the lithium-ion battery, and provides technical support for economic, efficient and safe operation of the lithium-ion battery, and has important practical significance and good application prospects.

A second object of the present disclosure is to propose a device for estimating the state of power based on the electrochemical model of the lithium-ion battery.

A third object of the present disclosure is to propose a non-transitory computer-readable storage medium.

A fourth object of the present disclosure is to propose an electronic device.

A fifth object of the present disclosure is to propose a computer program product.

A sixth object of the present disclosure is to propose a computer program.

To achieve the above purpose, embodiments of a first aspect of the present disclosure provide a method for estimating a state of power based on an electrochemical model of a lithium-ion battery, including: S1: obtaining an ambient temperature and an initial state of charge of the battery; S2: obtaining state information about the battery, and obtaining a simulation result of the battery at each moment within a preset time period based on the state information about the battery and the electrochemical model of the lithium-ion battery; S3: obtaining a maximum feasible current value of the battery within the preset time period by iteratively optimizing a simulation process in step S2 with the simulation result of the battery as constraints; S4: performing simulation by taking the maximum feasible current value as an amplitude of an input constant current sequence of a battery port to obtain a curve of a port voltage of the battery within the preset time period, obtaining maximum output power of the battery based on the curve of the port voltage of the battery and the amplitude of the constant current sequence, and taking the maximum output power of the battery as a maximum available power value corresponding to the ambient temperature and the initial state of charge of the battery; and S5: adjusting the ambient temperature and the initial state of charge of the battery, and repeating steps S1-S4 to obtain the maximum available power values corresponding to different ambient temperatures and different initial states of charge of the battery to obtain the state of power of the lithium-ion battery.

In one embodiment of the present disclosure, the state information about the battery includes: a lithium concentration on a surface of an electrode active material, an average lithium concentration of the electrode active material, a lithium concentration of an electrode electrolyte, and an initial temperature of the battery; and

the simulation result of the battery includes: the port voltage of the battery, the average lithium concentration of the electrode active material, an energy conversion efficiency, and a potential difference on a surface of an electrode.

In one embodiment of the present disclosure, obtaining the simulation result of the battery at each moment within the preset time period based on the state information about the battery and the simulation with the electrochemical model of the lithium-ion battery includes:
setting the amplitude of the current sequence of the port of the battery and an amplitude of an ambient temperature sequence to constant values;
at a starting moment of the preset time period, updating a parameter vector at a current moment based on the lithium concentration of the electrode electrolyte, the average lithium concentration of the electrode active material and a temperature of the battery at a previous moment:

$$θ ( k + 1 ) = {f}_{θ} ( {c}_{e} ( k ) , {c}_{s , av} ( k ) , {T}_{b} ( k ) )$$

where θ(k+1) represents the parameter vector at the current moment, ƒ_{θ} represents a parameter update function, cₑ(k) represents the lithium concentration of the electrode electrolyte at the previous moment, c_{s,av}(k) represents the average lithium concentration of the electrode active material at the previous moment, and T_{b} (k) represents the temperature of the battery at the previous moment;
updating a reaction current intensity at the current moment based on the lithium concentration of the electrode electrolyte at the previous moment, the lithium concentration on the surface of the electrode active material at the previous moment, the temperature of the battery at the previous moment, a current of the port at the previous moment and the parameter vector at the current moment:

$${j}_{n} ( k + 1 ) = {f}_{j} ( {c}_{e} ( k ) , {c}_{s , surf} ( k ) , {T}_{b} ( k ) , I ( k ) , θ ( k + 1 ) )$$

where jₙ(k+1) represents the reaction current intensity at the current moment, ƒⱼ represents a reaction current update function, cₑ(k) represents the lithium concentration of the electrode electrolyte at the previous moment, c_{s,surf}(k) represents the lithium concentration on the surface of the electrode active material at the previous moment, T_{b}(k) represents the temperature of the battery at the previous moment, I(k) represents the current of the port at the previous moment, and θ(k+1) represents the parameter vector at the current moment;
updating the potential difference on the solid-solution surface of the electrode at the current moment based on the reaction current intensity and the parameter vector at the current moment:

$${ϕ}_{se} ( k + 1 ) = {f}_{ϕ} ( {j}_{n} ( k + 1 ) , θ ( k + 1 ) )$$

where ϕₛₑ(k+1) represents the potential difference on the solid-solution surface of the electrode at the current moment, ƒ_{ϕ} represents an update function of the potential difference on the solid-solution surface of the electrode, jₙ(k+1) represents the reaction current intensity at the current moment, and θ(k+1) represents the parameter vector at the current moment;
updating the lithium concentration of the electrode active material at the current moment based on the average lithium concentration of the electrode active material at the previous moment, the lithium concentration on the surface of the electrode active material at the previous moment, the reaction current intensity at the current moment, the parameter vector at the current moment and a sampling interval:

$${c}_{s , av} ( k + 1 ) = {f}_{av} ( {c}_{s , av} ( k ) , {c}_{s , surf} ( k ) , {j}_{n} ( k + 1 ) , θ ( k + 1 ) , Δ t )$$

$${c}_{s , surf} ( k + 1 ) = {f}_{surf} ( {c}_{s , av} ( k ) , {c}_{s , surf} ( k ) , {j}_{n} ( k + 1 ) , θ ( k + 1 ) , Δ t )$$

where c_{s,av}(k+1) represents the average lithium concentration of the electrode active material at the current moment, ƒₐᵥ represents an update function of the average lithium concentration of the electrode active material, c_{s,av}(k) represents the average lithium concentration of the electrode active material at the previous moment, C_{s,surf}(k) represents the lithium concentration on the surface of the electrode active material at the previous moment, jₙ(k+1) represents the reaction current intensity at the current moment, θ(k+1) represents the parameter vector at the current moment, Δt represents the sampling interval, c_{s,surf}(k+1) represents the lithium concentration on the surface of the electrode active material at the current moment, ƒ_{surf} represents an update function of the lithium concentration on the surface of the electrode active material, c_{s,av}(k) represents the average lithium concentration of the electrode active material at the previous moment, C_{s,surf}(k) represents the lithium concentration on the surface of the electrode active material at the previous moment, jₙ(k+1) represents the reaction current intensity at the current moment, θ(k+1) represents the parameter vector at the current moment, and Δt represents the sampling interval;
updating the lithium concentration of the electrode electrolyte at the current moment based on the lithium concentration of the electrode electrolyte at the previous moment, the current of the port at the previous moment, the parameter vector at the current moment and the sampling interval:

$${c}_{e} ( k + 1 ) = {f}_{e} ( {c}_{e} ( k ) , I ( k ) , θ ( k + 1 ) , Δ t )$$

where cₑ(k+1) represents the lithium concentration of the electrode electrolyte at the current moment, ƒₑ represents an update function of the lithium concentration of the electrode electrolyte, cₑ (k) represents the lithium concentration of the electrode electrolyte at the previous moment, I(k) represents the current of the port at the previous moment, θ(k+1) represents the parameter vector at the current moment, and Δt represents the sampling interval;
obtaining a port voltage V of the battery and a potential difference U in the battery at the current moment based on the lithium concentration of the electrode electrolyte at the current moment, the lithium concentration on the surface of the electrode active material at the current moment, the reaction current intensity at the current moment, the parameter vector at the current moment, the temperature of the battery at the previous moment and the current of the port at the previous moment:

$$V ( k + 1 ) = {f}_{V} ( {c}_{e} ( k + 1 ) , {c}_{s , surf} ( k + 1 ) , {j}_{n} ( k + 1 ) , {T}_{b} ( k ) , I ( k ) , θ ( k + 1 ) )$$

$$U ( k + 1 ) = {f}_{U} ( {c}_{e} ( k + 1 ) , {c}_{s , surf} ( k + 1 ) , {j}_{n} ( k + 1 ) , {T}_{b} ( k ) , I ( k ) , θ ( k + 1 ) )$$

where V(k+1) represents the port voltage of the battery at the current moment, ƒᵥ represents an update function of the port voltage of the battery, cₑ (k+1) represents the lithium concentration of the electrode electrolyte at the current moment, c_{s,surf}(k+1) represents the lithium concentration on the surface of the electrode active material at the current moment, jₙ(k+1) represents the reaction current intensity at the current moment, T_{b}(k) represents the temperature of the battery at the previous moment, I(k) represents the current of the port at the previous moment, θ(k+1) represents the parameter vector at the current moment, U(k+1) represents the potential difference in the battery at the current moment, ƒ_{U} represents an update function of the potential difference in the battery, cₑ (k+1) represents the lithium concentration of the electrode electrolyte at the current moment, c_{s,surf}(k+1) represents the lithium concentration on the surface of the electrode active material at the current moment, jₙ(k+1) represents the reaction current intensity at the current moment, T_{b}(k) represents the temperature of the battery at the previous moment, I(k) represents the current of the port at the previous moment, and θ(k+1) represents the parameter vector at the current moment;
obtaining the temperature of the battery at the current moment based on the port voltage of the battery at the current moment, the potential difference in the battery at the current moment, the reaction current intensity at the current moment, the parameter vector at the current moment, the temperature of the battery at the previous moment, the ambient temperature at the previous moment, the current of the port at the previous moment and the sampling interval:

$${T}_{b} ( k + 1 ) = {f}_{T} ( V ( k + 1 ) , U ( k + 1 ) , {j}_{n} ( k + 1 ) , {T}_{b} ( k ) , {T}_{amb} ( k ) , I ( k ) , θ ( k + 1 ) , Δ t )$$

where T_{b} (k+1) represents the temperature of the battery at the current moment, ƒ_{T} represents an update function of the temperature of the battery, V(k+1) represents the port voltage of the battery at the current moment, U(k+1) represents the potential difference in the battery at the current moment, jₙ(k+1) represents the reaction current intensity at the current moment, T_{b} (k) represents the temperature of the battery at the previous moment, T_{amb}(k) represents the ambient temperature at the previous moment, I(k) represents the current of the port at the previous moment, θ(k+1) represents the parameter vector at the current moment, and Δt represents the sampling interval;
defining the energy conversion efficiency of the battery based on a charged or discharged state of the battery, the port voltage of the battery at the previous moment and the potential difference in the battery at the previous moment:

$$\{ \begin{matrix}η ( k ) = \frac{V ( k )}{U ( k )} , I ( k ) \geq 0 \\ η ( k ) = \frac{U ( k )}{V ( k )} , I ( k ) < 0\end{matrix}$$

where η(k) represents the energy conversion efficiency of the battery in the discharged state in a case where I(k)≥0, and η(k) represents the energy conversion efficiency of the battery in the charged state in a case where I(k)<0;
repeating the above-mentioned simulation, iteration and update steps, and cyclically updating a state value at the current moment from a state value at the previous moment: the parameter vector, the reaction current intensity, the potential difference on the surface of the electrode, the lithium concentration of the electrode active material, and the lithium concentration of the electrode electrolyte, and outputting the port voltage and the energy conversion efficiency of the battery based on a state update result until the preset time period ends to obtain the simulation result of the battery at each moment within the preset time period, where the simulation result of the battery includes: the port voltage of the battery, the average lithium concentration of the electrode active material, the energy conversion efficiency, and the potential difference on the surface of the electrode, and
where the simulation result of the battery is represented as:

$$[ V , {C}_{s} , η , {Φ}_{se} ] = {f}_{bat} ( {SOC}_{0} , {T}_{amb} , I )$$

where V represents the port voltage of the battery at each moment within the preset time period, Cₛ represents the average lithium concentration of the electrode active material at each moment within the preset time period, η represents the energy conversion efficiency at each moment within the preset time period, Φₛₑ represents the potential difference on the surface of the electrode at each moment within the preset time period, f_{bat} represents a set of state update functions, SOC₀ represents the initial state of charge, T_{amb} represents the ambient temperature of the battery, and I represents the amplitude of the constant current sequence of the port.

In one embodiment of the present disclosure, obtaining the maximum feasible current value of the port of the battery within the preset time period by iteratively optimizing the simulation process in step S2 with the simulation result of the battery as the constraints includes:
setting the constraints within the preset time period, defining an inequality error for the constraints, and calculating a Sigmoid function value corresponding to the constraints based on the inequality error to obtain a Sigmoid penalty term corresponding to the constraints, where the Sigmoid penalty term approaches 0 in a case where an inequality is established, and the Sigmoid penalty term is a certain larger value in a case where the inequality is not established;
where calculating the Sigmoid function value is represented as:

$${f}_{sig} = \frac{{M}_{1}}{1 + exp ( - {M}_{2} * E )}$$

where ƒ_{sig} represents a Sigmoid function, M₁ and M₂ each represent any larger constants, E represents the inequality error, and exp represents an exponential function with a natural constant e as a base;
performing iterative optimization to obtain the maximum feasible current value of the port of the battery satisfying the constraints within the preset time period, including:
representing a constrained optimization problem as an unconstrained optimization problem by substituting the Sigmoid penalty term corresponding to the constraints during charging or discharging,
where the unconstrained optimization problem during the discharging is represented as:

$${min}_{I} ( \text{} - I + {f}_{V , min} + {f}_{V , max} + {f}_{{cs}^{-} , min} + {f}_{c {s}^{-} , max} + {f}_{c {s}^{+} , min} + {f}_{c {s}^{+} , max} + {f}_{η , min} + {f}_{ϕ , min} )$$

the unconstrained optimization problem during the charging is represented as:

$${min}_{I} ( \text{} I + {f}_{V , min} + {f}_{V , max} + {f}_{{cs}^{-} , min} + {f}_{c {s}^{-} , max} + {f}_{c {s}^{+} , min} + {f}_{c {s}^{+} , max} + {f}_{η , min} + {f}_{ϕ , min} )$$

where ƒ_{V,min}, ƒ_{V,min}, ƒ_{cs}_{^{−}}_{,min}, ƒ_{cs}_{^{−}}_{,max}, ƒ_{cs}_{⁺}_{,min}, ƒ_{cs}_{⁺}_{,max}, ƒ_{η,min} and ƒ_{ϕ,min} are the Sigmoid penalty terms corresponding to the constraints, I represents the amplitude of the current sequence, and min represents a minimum function, and
where a process of the iterative optimization is solved via an optimization solver by calling an interior point process.

In one embodiment of the present disclosure, performing the simulation by taking the maximum feasible current value as the amplitude of the constant current sequence of the input port of the battery to obtain the curve of the port voltage of the battery within the preset time period, obtaining the maximum output power of the battery based on the curve of the port voltage of the battery and the amplitude of the constant current sequence, and taking the maximum output power of the battery as the maximum available power value corresponding to the ambient temperature and the initial state of charge of the battery include:
performing the simulation by taking the maximum feasible current value during the charging or discharging as the amplitude of the constant current sequence of the input port of the battery based on the ambient temperature and the initial state of charge of the battery, to obtain the curve of the port voltage of the battery during the charging or discharging within the preset time period;
obtaining an average port voltage during the charging or discharging based on the curve of the port voltage of the battery during the charging or discharging, calculating the maximum output power of the battery during the charging or discharging based on the average port voltage during the charging or discharging and the amplitude of the constant current sequence during the charging or discharging, and obtaining the feasible output power value during the charging or discharging corresponding to the ambient temperature and the initial state of charge of the battery, where
the simulations during the charging and discharging are respectively represented as:

$$[ {V}_{dis} , {C}_{s} , η , {Φ}_{se} ] = {f}_{bat} ( {SOC}_{0} , {T}_{amb} , {I}_{max} )$$

$$[ {V}_{char} , {C}_{s} , η , {Φ}_{se} ] = {f}_{bat} ( {SOC}_{0} , {T}_{amb} , {I}_{min} )$$

where V_{dis} represents the curve of the port voltage of the battery during the discharging, V_{char} represents the curve of the port voltage of the battery during the charging, Cₛ represents the average lithium concentration of the electrode active material at each moment within the preset time period, η represents the energy conversion efficiency at each moment within the preset time period, Φₛₑ represents the potential difference on the surface of the electrode at each moment within the preset time period, f_{bat} represents the set of state update functions, SOC₀ represents the initial state of charge, T_{amb} represents the ambient temperature of the battery, Iₘₐₓ represents the maximum feasible current value during the discharging, and Iₘᵢₙ represents the maximum feasible current value during the charging;
the average port voltages during the charging and discharging are respectively represented as:

$${\overline{V}}_{dis} = \frac{{V}_{{dis}_{1}} + {V}_{{dis}_{2}} + … + {V}_{{dis}_{k}} + … {V}_{{dis}_{N}}}{N}$$

$${\overline{V}}_{char} = \frac{{V}_{{char}_{1}} + {V}_{{char}_{2}} + … + {V}_{{char}_{k}} + … {V}_{{char}_{N}}}{N}$$

where V̅_{dis} represents the average port voltage during the discharging, V̅_{char} represents the average port voltage during the charging, and N represents a length of the preset time period;
the feasible output power values during the charging and discharging corresponding to the ambient temperature and the initial state of charge of the battery are respectively represented as:

$${P}_{dis} ( {SOC}_{0} , {T}_{amb} ) = {I}_{max} ( {SOC}_{0} , {T}_{amb} ) \times {\overline{V}}_{dis}$$

$${P}_{char} ( {SOC}_{0} , {T}_{amb} ) = {I}_{min} ( {SOC}_{0} , {T}_{amb} ) \times {\overline{V}}_{char}$$

where P_{dis}(SOC₀, T_{amb}) represents the feasible output power value corresponding to the ambient temperature and the initial state of charge of the battery during the discharging, P_{char}(SOC₀, T_{amb}) represents the feasible output power value corresponding to the ambient temperature and the initial state of charge of the battery during the charging, Iₘₐₓ(SOC₀, T_{amb}) represents the maximum feasible current value corresponding to the ambient temperature and the initial state of charge of the battery during the discharging, Iₘᵢₙ(SOC₀, T_{amb}) represents the maximum feasible current value corresponding to the ambient temperature and the initial state of charge of the battery during the charging, V_{dis} represents the average port voltage during the discharging, and V_{char} represents the average port voltage during the charging.

In one embodiment of the present disclosure, adjusting the ambient temperature and the initial state of charge of the battery, and repeating steps S1-S4 to obtain the maximum available power values corresponding to different ambient temperatures and different initial states of charge of the battery to obtain the state of power of the lithium-ion battery include:
adjusting the ambient temperature T_{amb} and the initial state of charge SOC₀ of the battery, and repeating steps S1-S4 to obtain the maximum available power value of the lithium-ion battery during the charging or discharging corresponding to different ambient temperatures and different initial states of charge of the battery, to form a curve of the state of power;
where the curve of the state of power is represented as:

$${P}_{char} ( {SOC}_{0} , {T}_{amb} ) \leq P ( {SOC}_{0} , {T}_{amb} ) \leq {P}_{dis} ( {SOC}_{0} , {T}_{amb} )$$

where P_{dis}(SOC₀, T_{amb}) represents the feasible output power value corresponding to the ambient temperature and the initial state of charge of the battery during the discharging, P_{char}(SOC₀, T_{amb}) represents the feasible output power value corresponding to the ambient temperature and the initial state of charge of the battery during the charging, and P(SOC₀, T_{amb}) represents an actual power value of the battery.

In one embodiment of the present disclosure, the method for estimating the state of power based on the electrochemical model of the lithium-ion battery further includes:
performing an approximate fitting processing on the state of power by using a piecewise linearization process in an engineering application.

Hereinafter, the method and device for estimating the state of power based on the electrochemical model of the lithium-ion battery in embodiments of the present disclosure will be described with reference to the accompanying drawings.

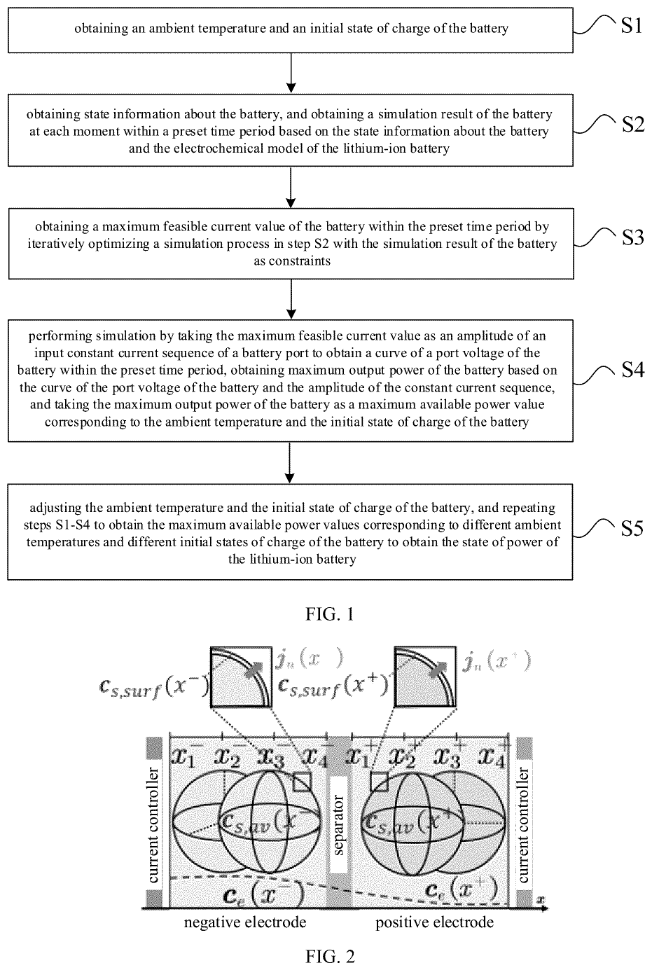

FIG. 1 is a flow chart illustrating a method for estimating a state of power based on an electrochemical model of a lithium-ion battery provided in an embodiment of the present disclosure.

As shown in FIG. 1, the method for estimating the state of power based on the electrochemical model of the lithium-ion battery includes the following steps:
S1: obtaining an ambient temperature and an initial state of charge of the battery;
S2: obtaining state information about the battery, and obtaining a simulation result of the battery at each moment within a preset time period based on the state information about the battery and the electrochemical model of the lithium-ion battery;
S3: obtaining a maximum feasible current value of the battery within the preset time period by iteratively optimizing a simulation process in step S2 with the simulation result of the battery as constraints;
S4: performing simulation by taking the maximum feasible current value as an amplitude of an input constant current sequence of a battery port to obtain a curve of a port voltage of the battery within the preset time period, obtaining maximum output power of the battery based on the curve of the port voltage of the battery and the amplitude of the constant current sequence, and taking the maximum output power of the battery as a maximum available power value corresponding to the ambient temperature and the initial state of charge of the battery; and
S5: adjusting the ambient temperature and the initial state of charge of the battery, and repeating steps S1-S4 to obtain the maximum available power values corresponding to different ambient temperatures and different initial states of charge of the battery to obtain the state of power of the lithium-ion battery.

The method for estimating the state of power based on the electrochemical model of the lithium-ion battery in embodiments of the present disclosure is performed by S1: obtaining the ambient temperature and the initial state of charge of the battery; S2: obtaining the state information about the battery, and obtaining the simulation result of the battery at each moment within the preset time period based on the state information about the battery and the electrochemical model of the lithium-ion battery; S3: obtaining the maximum feasible current value of the port of the battery within the preset time period by iteratively optimizing the simulation process in step S2 with the simulation result of the battery as the constraints; S4: performing the simulation by taking the maximum feasible current value as the amplitude of the constant current sequence of the input port of the battery to obtain the curve of the port voltage of the battery within the preset time period, obtaining the maximum output power of the battery based on the curve of the port voltage of the battery and the amplitude of the constant current sequence, and taking the maximum output power of the battery as the maximum available power value corresponding to the ambient temperature and the initial state of charge of the battery; and S5: adjusting the ambient temperature and the initial state of charge of the battery, and repeating steps S1-S4 to obtain the maximum available power values corresponding to different ambient temperatures and different initial states of charge of the battery to obtain the state of power of the lithium-ion battery. In this way, a problem that it is difficult to accurately estimate the state of power of the lithium-ion battery in the related art is solved, the influence of an internal state constraint of the battery on the feasible output power may be more comprehensively reflected, an operation characteristic of the lithium-ion battery under different sampling frequencies in a long period of time and a short period of time is completely retained, a purpose of more accurately and effectively estimating the current feasible output power of the battery according to an operation state of the lithium-ion battery is achieved, and technical support for economic, efficient and safe operation of the lithium-ion battery is provided, having important practical significance and good application prospects.

In embodiments of the present disclosure, the port voltage of the battery, an average lithium concentration of an electrode active material, an energy conversion efficiency, and a potential difference on a surface of an electrode are used as constraints during the operation of the lithium-ion battery, and the state of power is described by using a problem of nonlinear convex optimization based on construction and simulation technology of the electrochemical model, thereby implementing universal expansion of the method in a long period of time and a short period of time, and solving the problem of nonlinear convex optimization by using a relatively mature optimization solver. In the present disclosure, the feasible output power of the battery under different initial states of charge and ambient temperatures is optimized and solved, and a curve of a power output region during the charging or discharging with the state of charge and ambient temperature as independent variables is obtained.

The state of power of the lithium-ion battery obtained by the method for estimating the state of power based on the electrochemical model of the lithium-ion battery in embodiments of the present disclosure can accurately describe the maximum available power of the lithium-ion battery under different electrochemical states. The obtained state of power can be applied to a variety of scenarios such as long-term planning, day-ahead scheduling and real-time control in an energy storage system including lithium-ion batteries, so as to provide accurate and efficient power constraints for the optimized decision of the energy storage system of lithium ion batteries, and improve the efficiency and safety of the operation of the energy storage system of lithium-ion batteries.

For a single lithium-iron-phosphate battery cell with a nominal capacity of 1.22 Ah at room temperature of 25° C., by the method for estimating the state of power based on the electrochemical model of the lithium-ion battery in embodiments of the present disclosure, the upper limit of the state of charging power under different states of charge is estimated to be about 0.5 W to 5.5 W, and the upper limit of the state of discharging power under different states of charge is estimated to be about 0.6 W to 5.7 W. In the actual scheduling operation, the upper limits of charging and discharging power need to be set rationally according to the current state of charge of the battery cell to ensure the safe and efficient operation of the lithium-ion battery.

The ambient temperature and the initial state of charge of the battery are respectively represented as: T_{amb},SOC₀, where a domain of the initial state of charge is [0,1].

Further, in embodiments of the present disclosure, the state information about the battery includes: a lithium concentration on the surface of the electrode active material, the average lithium concentration of the electrode active material, a lithium concentration of an electrode electrolyte, and an initial temperature of the battery; and the simulation result of the battery includes: the port voltage of the battery, the average lithium concentration of the electrode active material, the energy conversion efficiency, and the potential difference on the surface of the electrode.

Further, in embodiments of the present disclosure, obtaining the simulation result of the battery at each moment within the preset time period based on the state information about the battery and the simulation with the electrochemical model of the lithium-ion battery includes:
obtaining a length N of the preset time period, and obtaining the state information about the battery, where the state information about the battery includes: the lithium concentration on the surface of the electrode active material, the average lithium concentration of the electrode active material, the lithium concentration of the electrode electrolyte, and the initial temperature of the battery;
obtaining the state information about the battery, including: obtaining a type of the electrode active material used for an electrode to be analysed, querying the average lithium concentration of the electrode active material corresponding to maximum and minimum states of charge of the electrode active material, obtaining an initial value of the average lithium concentration of the electrode active material according to a direct proportion relationship between the state of charge and the average lithium concentration, setting an initial uniform distribution of the lithium concentration of the electrode active material in an initial state, obtaining that the lithium concentration on the surface of the electrode active material is equal to the initial value of the average lithium concentration, obtaining an initial value of the lithium concentration of the electrode electrolyte according to parameter settings, and setting the initial temperature of the battery as the ambient temperature;
where the average lithium concentration of the electrode active material is represented as:

$${c}_{s , av}^{\pm } ( 0 ) = {f}_{init , c} ( {c}_{min}^{\pm } , {c}_{max}^{\pm } , {SOC}_{0} )$$

the lithium concentration on the surface of the electrode active material is represented as:

$${c}_{s , surf}^{\pm } ( 0 ) = {c}_{s , av}^{\pm } ( 0 )$$

the lithium concentration of the electrode electrolyte is represented as:

$${c}_{e} ( 0 ) = {f}_{init , e} ( {c}_{e 0} )$$

the initial temperature of the battery is represented as:

$${T}_{b} ( 0 ) = {T}_{amb}$$

where c_{s,av}^{±}(0) represents an initial value of the average lithium concentration of positive and negative electrode active materials, ƒ_{init,c} represents a set function of the initial value of the average lithium concentration of the electrode active materials, cₘᵢₙ^{±} represents a theoretical minimum value of the average lithium concentration of the positive and negative electrode active materials of the battery, cₘₐₓ^{±} represents a theoretical maximum value of the average lithium concentration of the positive and negative electrode active materials of the battery, SOC₀ represents the initial state of charge, c_{s,surf}^{±}(0) represents an initial value of the surface lithium concentration of the positive and negative electrode active materials, cₑ (0) represents the initial value of the lithium concentration of the electrode electrolyte, ƒ_{init,e} represents a set function of the initial value of the lithium concentration of the electrode electrolyte, cₑ₀ represents a material parameter of the lithium concentration of the electrode electrolyte, T_{b}(0) represents the initial temperature of the battery, and T_{amb} represents the ambient temperature of the battery;
the amplitude of the current sequence of the port of the battery and an amplitude of an ambient temperature sequence are set to constant values, which are respectively represented as:

$$I = {\underbrace{[ \begin{matrix}I & … & I\end{matrix} ]}}_{1 \times N} ,$$

$${T}_{amb} = {\underbrace{[ \begin{matrix}{T}_{amb} & … & {T}_{amb}\end{matrix} ]}}_{1 \times N}$$

where a period of action of the current and the ambient temperature at each moment is represented as tₖ≤t<tₖ₊₁, and a sampling interval is represented as Δt=tₖ₊₁−tₖ. The sign of the current is positive in a case where the battery is discharged, and is negative in a case where the battery is charged;
at a starting moment of the preset time period, updating a parameter vector at a current moment based on the lithium concentration of the electrode electrolyte, the average lithium concentration of the electrode active material and a temperature of the battery at a previous moment:

$$θ ( k + 1 ) = {f}_{θ} ( {c}_{e} ( k ) , {c}_{s , av} ( k ) , {T}_{b} ( k ) )$$

where θ(k+1) represents the parameter vector at the current moment, ƒ_{θ} represents a parameter update function, cₑ (k) represents the lithium concentration of the electrode electrolyte at the previous moment, c_{s,av}(k) represents the average lithium concentration of the electrode active material at the previous moment, and T_{b} (k) represents the temperature of the battery at the previous moment;
updating a reaction current intensity at the current moment based on the lithium concentration of the electrode electrolyte at the previous moment, the lithium concentration on the surface of the electrode active material at the previous moment, the temperature of the battery at the previous moment, the current of the port at the previous moment and the parameter vector at the current moment:

$${j}_{n} ( k + 1 ) = {f}_{j} ( {c}_{e} ( k ) , {c}_{s , surf} ( k ) , {T}_{b} ( k ) , I ( k ) , θ ( k + 1 ) )$$

where jₙ(k+1) represents the reaction current intensity at the current moment, ƒᵢ represents a reaction current update function, cₑ(k) represents the lithium concentration of the electrode electrolyte at the previous moment, c_{s,surf}(k) represents the lithium concentration on the surface of the electrode active material at the previous moment, T_{b}(k) represents the temperature of the battery at the previous moment, I(k) represents the current of the port at the previous moment, and θ(k+1) represents the parameter vector at the current moment;
updating the potential difference on the solid-solution surface of the electrode at the current moment based on the reaction current intensity and the parameter vector at the current moment:

$${ϕ}_{se} ( k + 1 ) = {f}_{ϕ} ( {j}_{n} ( k + 1 ) , θ ( k + 1 ) )$$

where ϕₛₑ (k+1) represents the potential difference on the solid-solution surface of the electrode at the current moment, ƒ_{ϕ} represents an update function of the potential difference on the surface of the electrode, jₙ(k+1) represents the reaction current intensity at the current moment, and θ(k+1) represents the parameter vector at the current moment;
updating the lithium concentration of the electrode active material at the current moment based on the average lithium concentration of the electrode active material at the previous moment, the lithium concentration on the surface of the electrode active material at the previous moment, the reaction current intensity at the current moment, the parameter vector at the current moment and a sampling interval:

$${c}_{s , av} ( k + 1 ) = {f}_{av} ( {c}_{s , av} ( k ) , {c}_{s , surf} ( k ) , {j}_{n} ( k + 1 ) , θ ( k + 1 ) , Δ t )$$

$${c}_{s , surf} ( k + 1 ) = {f}_{surf} ( {c}_{s , av} ( k ) , {c}_{s , surf} ( k ) , {j}_{n} ( k + 1 ) , θ ( k + 1 ) , Δ t )$$

where c_{s,av}(k+1) represents the average lithium concentration of the electrode active material at the current moment, ƒₐᵥ represents an update function of the average lithium concentration of the electrode active material, c_{s,av}(k) represents the average lithium concentration of the electrode active material at the previous moment, c_{s,surf}(k) represents the lithium concentration on the surface of the electrode active material at the previous moment, jₙ(k+1) represents the reaction current intensity at the current moment, θ(k+1) represents the parameter vector at the current moment, Δt represents the sampling interval, c_{s,surf}(k+1) represents the lithium concentration on the surface of the electrode active material at the current moment, ƒ_{surf} represents an update function of the lithium concentration on the surface of the electrode active material, c_{s,av}(k) represents the average lithium concentration of the electrode active material at the previous moment, c_{s,surf}(k) represents the lithium concentration on the surface of the electrode active material at the previous moment, jₙ(k+1) represents the reaction current intensity at the current moment, θ(k+1) represents the parameter vector at the current moment, and Δt represents the sampling interval;
updating the lithium concentration of the electrode electrolyte at the current moment based on the lithium concentration of the electrode electrolyte at the previous moment, the current of the port at the previous moment, the parameter vector at the current moment and the sampling interval:

$${c}_{e} ( k + 1 ) = {f}_{e} ( {c}_{e} ( k ) , I ( k ) , θ ( k + 1 ) , Δ t )$$

where cₑ (k+1) represents the lithium concentration of the electrode electrolyte at the current moment, ƒₑ represents an update function of the lithium concentration of the electrode electrolyte, cₑ (k) represents the lithium concentration of the electrode electrolyte at the previous moment, I(k) represents the current of the port at the previous moment, θ(k+1) represents the parameter vector at the current moment, and Δt represents the sampling interval;
obtaining a port voltage V of the battery and a potential difference U in the battery at the current moment based on the lithium concentration of the electrode electrolyte at the current moment, the lithium concentration on the surface of the electrode active material at the current moment, the reaction current intensity at the current moment, the parameter vector at the current moment, the temperature of the battery at the previous moment and the current of the port at the previous moment:

$$V ( k + 1 ) = {f}_{V} ( {c}_{e} ( k + 1 ) , {c}_{s , surf} ( k + 1 ) , {j}_{n} ( k + 1 ) , {T}_{b} ( k ) , I ( k ) , θ ( k + 1 ) )$$

$$U ( k + 1 ) = {f}_{U} ( {c}_{e} ( k + 1 ) , {c}_{s , surf} ( k + 1 ) , {j}_{n} ( k + 1 ) , {T}_{b} ( k ) , I ( k ) , θ ( k + 1 ) )$$

where V(k+1) represents the port voltage of the battery at the current moment, ƒᵥ represents an update function of the port voltage of the battery, cₑ (k+1) represents the lithium concentration of the electrode electrolyte at the current moment, c_{s,surf}(k+1) represents the lithium concentration on the surface of the electrode active material at the current moment, jₙ(k+1) represents the reaction current intensity at the current moment, T_{b}(k) represents the temperature of the battery at the previous moment, I(k) represents the current of the port at the previous moment, θ(k+1) represents the parameter vector at the current moment, U(k+1) represents the potential difference in the battery at the current moment, ƒ_{U} represents an update function of the potential difference in the battery, cₑ (k+1) represents the lithium concentration of the electrode electrolyte at the current moment, c_{s,surf}(k+1) represents the lithium concentration on the surface of the electrode active material at the current moment, jₙ(k+1) represents the reaction current intensity at the current moment, T_{b}(k) represents the temperature of the battery at the previous moment, I(k) represents the current of the port at the previous moment, and θ(k+1) represents the parameter vector at the current moment;
obtaining the temperature of the battery at the current moment based on the port voltage of the battery at the current moment, the potential difference in the battery at the current moment, the reaction current intensity at the current moment, the parameter vector at the current moment, the temperature of the battery at the previous moment, the ambient temperature at the previous moment, the current of the port at the previous moment and the sampling interval:

$${T}_{b} ( k + 1 ) = {f}_{T} ( V ( k + 1 ) , U ( k + 1 ) , {j}_{n} ( k + 1 ) , {T}_{b} ( k ) , {T}_{amb} ( k ) , I ( k ) , θ ( k + 1 ) , Δ t )$$

where T_{b} (k+1) represents the temperature of the battery at the current moment, ƒ_{T} represents an update function of the temperature of the battery, V(k+1) represents the port voltage of the battery at the current moment, U(k+1) represents the potential difference in the battery at the current moment, jₙ(k+1) represents the reaction current intensity at the current moment, T_{b} (k) represents the temperature of the battery at the previous moment, T_{amb} (k) represents the ambient temperature at the previous moment, I(k) represents the current of the port at the previous moment, θ(k+1) represents the parameter vector at the current moment, and Δt represents the sampling interval;
defining the energy conversion efficiency of the battery based on a charged or discharged state of the battery, the port voltage of the battery at the current moment and the potential difference in the battery at the current moment:

$$\{ \begin{matrix}η ( k ) = \frac{V ( k )}{U ( k )} , I ( k ) \geq 0 \\ η ( k ) = \frac{U ( k )}{V ( k )} , I ( k ) < 0\end{matrix}$$

where η(k) represents the energy conversion efficiency of the battery in the discharged state in a case where I(k)≥0, and η(k) represents the energy conversion efficiency of the battery in the charged state in a case where I(k)<0;
repeating the above-mentioned simulation, iteration and update steps, and cyclically updating a state value at the current moment from a state value at the previous moment: the parameter vector, the reaction current intensity, the potential difference on the surface of the electrode, the lithium concentration of the electrode active material, and the lithium concentration of the electrode electrolyte, and outputting the port voltage and the energy conversion efficiency of the battery based on a state update result until the preset time period ends to obtain the port voltage V=[V₁ V₂ . . . Vₖ . . . V_{N}] of the battery, the average lithium concentration Cₛ=[c_{s,av}_{₁}, c_{s,av}_{₂} . . . c_{s,av}_{ₖ} . . . c_{s,av}_{_{N}}] of the electrode active material, the energy conversion efficiency η=[η₁η₂ . . . ηₖ . . . η_{N}], and the potential difference Φₛₑ=[ϕₛₑ_{₁}, ϕₛₑ_{₂} . . . ϕₛₑ_{ₖ} . . . ϕₛₑ_{_{N}}] on the surface of the electrode at each moment within the preset time period, and to obtain the simulation result of the battery at each moment within the preset time period;
where the simulation result of the battery is represented as:

$$[ V , {C}_{s} , η , {Φ}_{se} ] = {f}_{bat} ( {SOC}_{0} , {T}_{amb} , I )$$

where V represents the port voltage of the battery at each moment within the preset time period, Cₛ represents the average lithium concentration of the electrode active material at each moment within the preset time period, η represents the energy conversion efficiency at each moment within the preset time period, Φₛₑ represents the potential difference on the surface of the electrode at each moment within the preset time period, f_{bat} represents a set of state update functions, SOC₀ represents the initial state of charge, T_{amb} represents the ambient temperature of the battery, I represents the amplitude of the constant current sequence of the port; Cₛ, Φₛₑ represent 8×N matrices, a transverse vector represents a total of 8 sampling points in positive and negative electrodes, and a longitudinal vector represents a total of N sampling moments of a preset time period of a sampling point.

In the present disclosure, parameters such as the reaction current intensity, the potential difference on the surface of the electrode, the lithium concentration of the electrode electrolyte, the lithium concentration on the surface of the electrode active material, and the average lithium concentration of the electrode active material are all vectors, and there are 8 sampling points in space at each moment, and specific examples are as follows:

The reaction current intensity, the potential difference on the surface of the electrode, the lithium concentration of the electrode electrolyte, the lithium concentration on the surface of the electrode active material, and the average lithium concentration of the electrode active material, by taking 4 sampling points at the positive and negative electrodes of the battery in the direction of increase in electrode thickness direction respectively, as shown in FIG. 1, are represented as:

$${j}_{n} ( k ) = [ {j}_{n} ( {x}_{1}^{\pm } , k ) , … , {j}_{n} ( {x}_{4}^{\pm } , k ) ]$$

$${ϕ}_{se} ( k ) = [ {ϕ}_{se} ( {x}_{1}^{\pm } , k ) , … , {ϕ}_{se} ( {x}_{4}^{\pm } , k ) ]$$

$${c}_{e} ( k ) = [ {c}_{e} ( {x}_{1}^{\pm } , k ) , … , {c}_{e} ( {x}_{4}^{\pm } , k ) ]$$

$${c}_{s , av} ( k ) = [ {c}_{s , av} ( {x}_{1}^{\pm } , k ) , … , {c}_{s , av} ( {x}_{4}^{\pm } , k ) ]$$

$${c}_{s , surf} ( k ) = [ {c}_{s , surf} ( {x}_{1}^{\pm } , k ) , … , {c}_{s , surf} ( {x}_{4}^{\pm } , k ) ]$$

where jₙ(k) represents the reaction current intensity at the current moment, jₙ(x₁^{±}, k) represents the reaction current intensity at sampling point 1 at the current moment, jₙ(x₄^{±}, k) represents the reaction current intensity at sampling point 4 at the current moment, ϕₛₑ (k) represents the potential difference on the solid-solution surface of the electrode at the current moment, ϕₛₑ (x₁^{±}, k) represents the potential difference on the surface of the electrode at the sampling point 1 at the current moment, ϕₛₑ(x₁^{±}, k) represents the potential difference on the surface of the electrode at the sampling point 4 at the current moment, cₑ (k) represents the lithium concentration of the electrode electrolyte at the current moment, cₑ(x₁^{±},k) represents the lithium concentration of the electrode electrolyte at the sampling point 1 at the current moment, cₑ (x₄^{±}, k) represents the lithium concentration of the electrode electrolyte at the sampling point 4 at the current moment, C_{s,av}(k) represents the average lithium concentration of the electrode active material at the current moment, c_{s,av} (x₁^{±}, k) represents the average lithium concentration of the electrode active material at the sampling point 1 at the current moment, c_{s,av}(x₄^{±},k) represents the average lithium concentration of the electrode active material at the sampling point 4 at the current moment, C_{s,surf} (k) represents the lithium concentration on the surface of the electrode active material at the current moment, c_{s,surf}(x₁^{±}, k) represents the lithium concentration on the surface of the electrode active material at the sampling point 1 at the current moment, and c_{s,surf} (x₁^{±}, k) represents the lithium concentration on the surface of the electrode active material at the sampling point 4 at the current moment.

Further, in embodiments of the present disclosure, obtaining the maximum feasible current value of the port of the battery within the preset time period by iteratively optimizing the simulation process in step S2 with the simulation result of the battery as the constraints includes:
setting the constraints within the preset time period, defining an inequality error for the constraints, and calculating a Sigmoid function value corresponding to the constraints based on the inequality error to obtain a Sigmoid penalty term corresponding to the constraints, where the Sigmoid penalty term approaches 0 in a case where an inequality is established, and the Sigmoid penalty term is a certain larger value, e.g., a value close to M in the Sigmoid function, in a case where the inequality is not established;
where a constraint on the port voltage of the battery is represented as:

$${U}_{min} \leq V \leq {U}_{max}$$

an inequality error defined for the constraint on the port voltage of the battery is represented as:

$${E}_{V , min} = {U}_{min} - min ( V ) ,$$

$${E}_{V , max} = max ( V ) - {U}_{max}$$

where V represents the port voltage of the battery, Uₘₐₓ, Uₘᵢₙ represent an upper limit and a lower limit of the port voltage of the battery, respectively, E_{V,min} represents a lower limit error of the port voltage of the battery, min(V) represents a minimum value of the port voltage of the battery, E_{V,max} represents an upper limit error of the port voltage of the battery, and max(V) represents a maximum value of the port voltage of the battery;
a constraint on the average lithium concentration of the electrode active material is represented as:

$${y}_{0}^{-} {c}_{s , max}^{-} \leq {C}_{s} ( {x}^{-} ) \leq {y}_{1}^{-} {c}_{s , max}^{-} ,$$

$${y}_{0}^{+} {c}_{s , max}^{+} \leq {C}_{s} ( {x}^{+} ) \leq {y}_{1}^{+} {c}_{s , max}^{+}$$

an inequality error defined for the constraint on the average lithium concentration of the electrode active material is represented as:

$${E}_{{cs}^{-} , min} = {y}_{0}^{-} {c}_{s , max}^{-} - min ( {C}_{s} ( {x}^{-} ) ) , {E}_{{cs}^{-} , max} = max ( {C}_{s} ( {x}^{-} ) ) - {y}_{1}^{-} {c}_{s , max}^{-}$$

$${E}_{{cs}^{+} , min} = {y}_{0}^{+} {c}_{s , max}^{+} - min ( {C}_{s} ( {x}^{+} ) ) , {E}_{{cs}^{+} , max} = max ( {C}_{s} ( {x}^{+} ) ) - {y}_{1}^{+} {c}_{s , max}^{+}$$

where Cₛ(x⁻) represents the average lithium concentration of the negative electrode active material, Cₛ(x⁺) represents the average lithium concentration of the positive electrode active material, y₀⁻ represents a lower limit of the average lithium concentration of the negative electrode active material expressed in percentage, y₁⁻ represents an upper limit of the average lithium concentration of the negative electrode active material expressed in percentage, y₀⁺ represents a lower limit of the average lithium concentration of the positive electrode active material expressed in percentage, y₁⁺ represents an upper limit of the average lithium concentration of the positive electrode active material expressed in percentage, C_{s,max}⁻ represents a maximum value of the average lithium concentration of the negative electrode active material, c_{s,max}⁺ represents a maximum value of the average lithium concentration of the positive electrode active material, E_{cs}_{^{−}}_{,min} represents a lower limit error of the average lithium concentration of the negative electrode active material, E_{cs}_{^{−}}_{,max} represents an upper limit error of the average lithium concentration of the negative electrode active material, E_{cs}_{⁺}_{,min} represents a lower limit error of the average lithium concentration of the positive electrode active material, E_{cs}_{⁺}_{,max} represents an upper limit error of the average lithium concentration of the positive electrode active material, min(Cₛ(x⁻)) represents a minimum value of the average lithium concentration of the negative electrode active material, max(Cₛ(x⁻)) represents a maximum value of the average lithium concentration of the negative electrode active material, min(Cₛ(x⁺)) represents a minimum value of the average lithium concentration of the positive electrode active material, and max(Cₛ(x⁺)) represents a maximum value of the average lithium concentration of the positive electrode active material;
a constraint on the energy conversion efficiency of the battery is represented as:

$$η \geq {η}_{min}$$

an inequality error defined for the constraint on the energy conversion efficiency of the battery is represented as:

$${E}_{η , min} = {η}_{min} - min ( η )$$

where η represents the energy conversion efficiency of the battery, ηₘᵢₙ represents a lower limit of the energy conversion efficiency of the battery, E_{η,min} represents a lower limit error of the energy conversion efficiency of the battery, and min(η) represents a minimum value of the energy conversion efficiency of the battery;
a constraint on the potential difference on a surface of a negative electrode is represented as:

$${Φ}_{s e} ( {x}^{-} ) \geq Δ {ϕ}_{m i n}$$

an inequality error defined for the constraint on the potential difference on the surface of the negative electrode is represented as:

$${E}_{ϕ , m i n} = Δ {ϕ}_{m i n} - min ( {Φ}_{s e} ( {x}^{-} ) )$$

where Φₛₑ(x⁻) represents the potential difference on the surface of the negative electrode, Δϕₘᵢₙ represents a lower limit of the constraint on the potential difference on the surface of the negative electrode, E_{ϕ,min} represents a lower limit error of the potential difference on the surface of the negative electrode, and min(Φₛₑ(x⁻)) represents a minimum value of the potential difference on the surface of the negative electrode;
where calculating the Sigmoid function value is represented as:

$${f}_{sig} = \frac{{M}_{1}}{1 + exp ( - {M}_{2} * E )}$$

where ƒ_{sig} represents a Sigmoid function, M₁ and M₂ each represent any larger constants, e.g., a constant greater than 10,000, E represents the inequality error, and exp represents an exponential function with a natural constant e as a base;
performing iterative optimization to obtain the maximum feasible current value of the port of the battery satisfying the constraints within the preset time period, including:
representing a constrained optimization problem as an unconstrained optimization problem by substituting the Sigmoid penalty term corresponding to the constraints during charging or discharging,
where the unconstrained optimization problem during the discharging is represented as:

$${min}_{I} ( - I + {f}_{V , m i n} + {f}_{V , m ax} + {f}_{c {s}^{-} , m i n} + {f}_{c {s}^{-} , m ax} + {f}_{c {s}^{+} , m i n} + {f}_{c {s}^{+} , m ax} + {f}_{η , m i n} + {f}_{ϕ , m i n} )$$

the unconstrained optimization problem during the charging is represented as:

$${min}_{I} ( I + {f}_{V , m i n} + {f}_{V , m ax} + {f}_{c {s}^{-} , m i n} + {f}_{c {s}^{-} , m ax} + {f}_{c {s}^{+} , m i n} + {f}_{c {s}^{+} , m ax} + {f}_{η , m i n} + {f}_{ϕ , m i n} )$$

where ƒ_{V,min}, ƒ_{V,max}, ƒ_{cs}_{^{−}}_{,min}, ƒ_{cs}_{^{−}}_{,max}, ƒ_{cs}_{⁺}_{,min}, ƒ_{cs}_{⁺}_{,max}, ƒ_{η,min} and ƒ_{ϕ,min} are the Sigmoid penalty terms corresponding to the constraints, I represents the amplitude of the current sequence, and min represents a minimum function, and
where a process of the iterative optimization is solved via an optimization solver by calling an interior point process, specifically: a feasible region of the optimization problem is described by the penalty function of the interior point process, and the optimal solution is obtained in the feasible region.

The constant constraints of a constant lithium-ion battery are set by referring to an upper limit parameter and a lower limit parameter as shown in Table 1, and the constraints of the lithium-ion battery changing along with the temperature is set by referring to the upper limit parameter and the lower limit parameter as shown in Table 2.

TABLE 1

Parameter

| Type of | | [Uₘᵢₙ, | | |
|---|---|---|---|---|
| battery | ηₘᵢₙ | Uₘₐₓ] | [y₀⁻, y₁⁻] | [y₀⁺, y₁⁺] |
| LiFePO₄ | 0.995 | [2.00, | [0.0001, | [0.0578, |
| | | 3.71] | 0.5763] | 0.9121] |
| Li(NiCoMn)O₂ | 0.995 | [2.64, | [0.0488, | [0.3578, |
| | | 4.21] | 0.9057] | 0.9378] |

TABLE 2

| Type of | Temperature | | | | | | |
|---|---|---|---|---|---|---|---|
| battery | 263.15 | 273.15 | 283.15 | 293.15 | 298.15 | 303.15 | 313.15 |
| LiFePO₄ | 0.0855 | 0.0865 | 0.0880 | 0.0900 | 0.0920 | 0.0925 | 0.0935 |
| Li(NiCoMn)O₂ | 0.0780 | 0.0790 | 0.0800 | 0.0810 | 0.0815 | 0.0820 | 0.0830 |

Further, in embodiments of the present disclosure, performing the simulation by taking the maximum feasible current value as the amplitude of the constant current sequence of the input port of the battery to obtain the curve of the port voltage of the battery within the preset time period, obtaining the maximum output power of the battery based on the curve of the port voltage of the battery and the amplitude of the constant current sequence, and taking the maximum output power of the battery as the maximum available power value corresponding to the ambient temperature and the initial state of charge of the battery include:
where Iₘₐₓ represents an iterative optimization result during the discharging, Iₘᵢₙ represents an iterative optimization result during the charging, and the current sequences of the port of the battery are respectively represented as:

$${I}_{m ax} = {\underbrace{[ {I}_{m ax} … {I}_{m ax} ]}}_{1 \times N} , {I}_{m i n} = {\underbrace{[ {I}_{m i n} … {I}_{m i n} ]}}_{1 \times N}$$

performing the simulation by taking the maximum feasible current value during the charging or discharging as the amplitude of the constant current sequence of the input port of the battery based on the ambient temperature and the initial state of charge of the battery, to obtain the curve of the port voltage of the battery during the charging or discharging within the preset time period;
obtaining the average port voltage during the charging or discharging based on the curve of the port voltage of the battery during the charging or discharging, calculating the maximum output power of the battery during the charging or discharging based on the average port voltage during the charging or discharging and the amplitude of the constant current sequence during the charging or discharging, and obtaining the feasible output power value during the charging or discharging corresponding to the ambient temperature and the initial state of charge of the battery, where
the simulations during the charging and discharging are respectively represented as:

$$[ {V}_{dis} , {C}_{s} , η , {Φ}_{s e} ] = {f}_{bat} ( {SOC}_{0} , {T}_{amb} , {I}_{m ax} )$$

$$[ {V}_{char} , {C}_{s} , η , {Φ}_{s e} ] = {f}_{bat} ( {SOC}_{0} , {T}_{amb} , {I}_{m i n} )$$

where V_{dis} represents the curve of the port voltage of the battery during the discharging, V_{char} represents the curve of the port voltage of the battery during the charging, Cₛ represents the average lithium concentration of the electrode active material at each moment within the preset time period, η represents the energy conversion efficiency at each moment within the preset time period, Φₛₑ represents the potential difference on the surface of the electrode at each moment within the preset time period, f_{bat} represents the set of state update functions, SOC₀ represents the initial state of charge, T_{amb} represents the ambient temperature of the battery, Iₘₐₓ represents the maximum feasible current value during the discharging, and Iₘᵢₙ represents the maximum feasible current value during the charging;
the average port voltages during the charging and discharging are respectively represented as:

$${\overline{V}}_{dis} = \frac{{V}_{{dis}_{1}} + {V}_{{dis}_{2}} + … + {V}_{{dis}_{k}} + … {V}_{{dis}_{N}}}{N}$$

$${\overline{V}}_{char} = \frac{{V}_{{char}_{1}} + {V}_{{char}_{2}} + … + {V}_{{char}_{k}} + … {V}_{{char}_{N}}}{N}$$

where V̅_{dis} represents the average port voltage during the discharging, V̅_{char} represents the average port voltage during the charging, and N represents the length of the preset time period;
the feasible output power values during the charging and discharging corresponding to the ambient temperature and the initial state of charge of the battery are respectively represented as:

$${P}_{dis} ( {SOC}_{0} , {T}_{amb} ) = {I}_{m ax} ( {SOC}_{0} , {T}_{amb} ) \times {\overline{V}}_{dis}$$

$${P}_{char} ( {SOC}_{0} , {T}_{amb} ) = {I}_{m i n} ( {SOC}_{0} , {T}_{amb} ) \times {\overline{V}}_{char}$$

where P_{dis}(SOC₀, T_{amb}) represents the feasible output power value corresponding to the ambient temperature and the initial state of charge of the battery during the discharging, P_{char}(SOC₀, T_{amb}) represents the feasible output power value corresponding to the ambient temperature and the initial state of charge of the battery during the charging, Iₘₐₓ(SOC₀, T_{amb}) represents the maximum feasible current value corresponding to the ambient temperature and the initial state of charge of the battery during the discharging, Iₘᵢₙ(SOC₀, T_{amb}) represents the maximum feasible current value corresponding to the ambient temperature and the initial state of charge of the battery during the charging, V̅_{dis} represents the average port voltage during the discharging, and V̅_{char} represents the average port voltage during the charging.

Further, in embodiments of the present disclosure, adjusting the ambient temperature and the initial state of charge of the battery, and repeating steps S1-S4 to obtain the maximum available power values corresponding to different ambient temperatures and different initial states of charge of the battery to obtain the state of power of the lithium-ion battery include:
adjusting the ambient temperature T_{amb} and the initial state of charge SOC₀ of the battery, and repeating steps S1-S4 to obtain the maximum available power value of the lithium-ion battery during the charging or discharging corresponding to different ambient temperatures and different initial states of charge of the battery, to form a curve of the state of power;
where the curve of the state of power is represented as:

$${P}_{char} ( {SOC}_{0} , {T}_{amb} ) \leq P ( {SOC}_{0} , {T}_{amb} ) \leq {P}_{dis} ( {SOC}_{0} , {T}_{amb} )$$

where P_{dis}(SOC₀, T_{amb}) represents the feasible output power value corresponding to the ambient temperature and the initial state of charge of the battery during the discharging, P_{char}(SOC₀, T_{amb}) represents the feasible output power value corresponding to the ambient temperature and the initial state of charge of the battery during the charging, and P(SOC₀, T_{amb}) represents an actual power value of the battery.

Further, in embodiments of the present disclosure, the method further includes:
performing an approximate fitting processing on the state of power by using a piecewise linearization process in an engineering application.

The curve of the state of power is divided into M segments, and M division points are represented as h₁, . . . , h_{M+1}. In an m^{th} segment, linear fitting is performed on the curve of the state of power during the charging and discharging to obtain constant coefficients b_{0,dis}^{m}(T_{amb}), b_{0,char}^{m}(T_{amb}) and first-order coefficients b_{1,dis}^{m}(T_{amb}), b_{1,char}^{m}(T_{amb}) respectively, and the above curves of the state of power during the charging and discharging may be piecewise linearly approximated as:

$$\{ \begin{matrix}{P}_{dis} ( {SOC}_{0} , {T}_{amb} ) \approx {b}_{1 , dis}^{m} ( {T}_{amb} ) \times {SOC}_{0} + {b}_{0 , dis}^{m} ( {T}_{amb} ) \\ {P}_{char} ( {SOC}_{0} , {T}_{amb} ) \approx {b}_{1 , char}^{m} ( {T}_{amb} ) \times {SOC}_{0} + {b}_{0 , char}^{m} ( {T}_{amb} )\end{matrix} ,$$

$${h}_{m} \leq {SOC}_{0} \leq {h}_{m + 1} , 1 \leq m \leq M$$

where the state of power during the charging and discharging are both convex regions, i.e. first-order linear fitting coefficients satisfy b_{1,dis}^{m+1}(T_{amb})≤b_{1,dis}^{m}(T_{amb}), b_{1,char}^{m+1}(T_{amb})≥b_{1,char}^{m}(T_{amb}), ∀m.

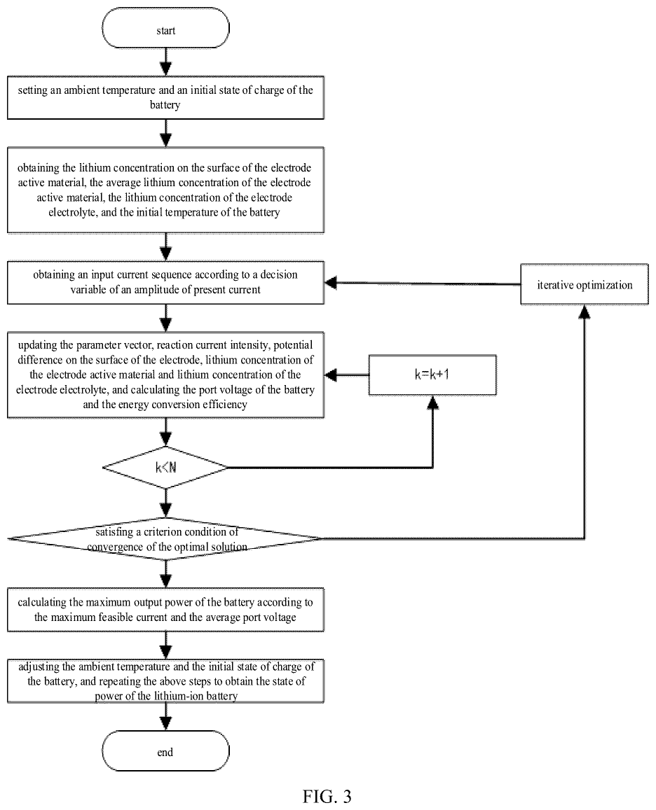

FIG. 3 is another flow chart illustrating a method for estimating a state of power based on an electrochemical model of a lithium-ion battery in embodiments of the present disclosure.

As shown in FIG. 3, the ambient temperature and the initial state of charge of the battery are obtained according to settings to obtain an initial value of a related battery state, and the simulation with the electrochemical model of the lithium-ion battery is performed to update relevant battery parameters. Some battery parameters are taken as constraint objects, the maximum feasible current value is obtained through iterative optimization, and a maximum available power value of the battery under the current setting is obtained according to the maximum feasible current value and the average port voltage obtained through the simulation. The above steps are repeated to obtain the maximum available power value of the battery under different ambient temperatures and different initial states of charge of the battery, and this is taken as the state of power of the lithium-ion battery.

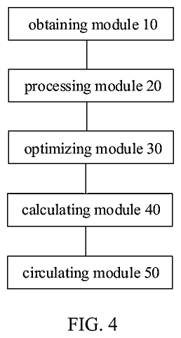

FIG. 4 is a schematic block diagram illustrating a device for estimating a state of power based on an electrochemical model of a lithium-ion battery provided in an embodiment of the present disclosure.

As shown in FIG. 4, the device for estimating the state of power based on the electrochemical model of the lithium-ion battery, including:
an obtaining module 10 configured to obtain an ambient temperature and an initial state of charge of the battery;
a processing module 20 configured to obtain state information about the battery, and to obtain a simulation result of the battery at each moment within a preset time period based on the state information about the battery and the electrochemical model of the lithium-ion battery;
an optimizing module 30 configured to obtain a maximum feasible current value of the battery within the preset time period by iteratively optimizing a simulation process in the processing module 20 with the simulation result of the battery as constraints;
a calculating module 40 configured to perform the simulation by taking the maximum feasible current value as an amplitude of an input constant current sequence of a battery port to obtain a curve of a port voltage of the battery within the preset time period, obtain a maximum output power of the battery based on the curve of the port voltage of the battery and the amplitude of the constant current sequence, and take the maximum output power of the battery as a maximum available power value corresponding to the ambient temperature and the initial state of charge of the battery; and
a circulating module 50 configured to adjust the ambient temperature and the initial state of charge of the battery, repeat to invoke the obtaining module, the processing module, the optimizing module, and the calculating module to obtain the maximum available power values corresponding to different ambient temperatures and different initial states of charge of the battery to obtain the state of power of the lithium-ion battery.

The device for estimating the state of power based on the electrochemical model of the lithium-ion battery in embodiments of the present disclosure includes the obtaining module configured to obtain the ambient temperature and the initial state of charge of the battery; the processing module configured to obtain the state information about the battery, and to obtain the simulation result of the battery at each moment within the preset time period based on the state information about the battery and the simulation with the electrochemical model of the lithium-ion battery; the optimizing module configured to obtain the maximum feasible current value of the port of the battery within the preset time period by iteratively optimizing the simulation process in the processing module with the simulation result of the battery as the constraints; the calculating module configured to perform the simulation calculation by taking the maximum feasible current value as the amplitude of the constant current sequence of the input port of the battery to obtain the curve of the port voltage of the battery within the preset time period, obtain the maximum output power of the battery based on the curve of the port voltage of the battery and the amplitude of the constant current sequence, and take the maximum output power of the battery as the maximum available power value corresponding to the ambient temperature and the initial state of charge of the battery; and the circulating module configured to adjust the ambient temperature and the initial state of charge of the battery, repeat to invoke the obtaining module, the processing module, the optimizing module, and the calculating module to obtain the maximum available power values corresponding to different ambient temperatures and different initial states of charge of the battery to obtain the state of power of the lithium-ion battery. In this way, the problem that it is difficult to accurately estimate the state of power of the lithium-ion battery is solved, the influence of the internal state constraint of the battery on the feasible output power may be more comprehensively reflected, the operation characteristic of the lithium-ion battery under different sampling frequencies in a long period of time and a short period of time is completely retained, the purpose of more accurately and effectively estimating the current feasible output power of the battery according to the operation state of the lithium-ion battery is achieved, and technical support for economic, efficient and safe operation of the lithium-ion battery is provided, having important practical significance and good application prospects.

Further, in embodiments of the present disclosure, the processing module 20 is configured to:
set the amplitude of the current sequence of the port of the battery and an amplitude of an ambient temperature sequence to constant values;
at a starting moment of the preset time period, update a parameter vector at a current moment based on the lithium concentration of the electrode electrolyte, the average lithium concentration of the electrode active material and the temperature of the battery at a previous moment:

$$θ ( k + 1 ) = {f}_{θ} ( {c}_{e} ( k ) , {c}_{s , av} ( k ) , {T}_{b} ( k ) )$$

where θ(k+1) represents the parameter vector at the current moment, ƒ_{θ} represents a parameter update function, cₑ(k) represents the lithium concentration of the electrode electrolyte at the previous moment, c_{s,av}(k) represents the average lithium concentration of the electrode active material at the previous moment, and T_{b} (k) represents the temperature of the battery at the previous moment;
update a reaction current intensity at the current moment based on the lithium concentration of the electrode electrolyte at the previous moment, the lithium concentration on the surface of the electrode active material at the previous moment, the temperature of the battery at the previous moment, a current of the port at the previous moment and the parameter vector at the current moment:

$${j}_{n} ( k + 1 ) = {f}_{j} ( {c}_{e} ( k ) , {c}_{s , surf} ( k ) , {T}_{b} ( k ) , I ( k ) , θ ( k + 1 ) )$$

where jₙ(k+1) represents the reaction current intensity at the current moment, ƒⱼ represents a reaction current update function, cₑ(k) represents the lithium concentration of the electrode electrolyte at the previous moment, c_{s,surf}(k) represents the lithium concentration on the surface of the electrode active material at the previous moment, T_{b}(k) represents the temperature of the battery at the previous moment, I(k) represents the current of the port at the previous moment, and θ(k+1) represents the parameter vector at the current moment;
update the potential difference on the solid-solution surface of the electrode at the current moment based on the reaction current intensity and the parameter vector at the current moment:

$${ϕ}_{se} ( k + 1 ) = {f}_{ϕ} ( {j}_{n} ( k + 1 ) , θ ( k + 1 ) )$$

where ϕₛₑ (k+1) represents the potential difference on the solid-solution surface of the electrode at the current moment, ƒ_{ϕ} represents an update function of the potential difference on the surface of the electrode, jₙ(k+1) represents the reaction current intensity at the current moment, and θ(k+1) represents the parameter vector at the current moment;
update the lithium concentration of the electrode active material at the current moment based on the average lithium concentration of the electrode active material at the previous moment, the lithium concentration on the surface of the electrode active material at the previous moment, the reaction current intensity at the current moment, the parameter vector at the current moment and a sampling interval:

$${c}_{s , av} ( k + 1 ) = {f}_{av} ( {c}_{s , av} ( k ) , {c}_{s , surf} ( k ) , {j}_{n} ( k + 1 ) , θ ( k + 1 ) , Δ t )$$

$${c}_{s , surf} ( k + 1 ) = {f}_{surf} ( {c}_{s , av} ( k ) , {c}_{s , surf} ( k ) , {j}_{n} ( k + 1 ) , θ ( k + 1 ) , Δ t )$$

where c_{s,av}(k+1) represents the average lithium concentration of the electrode active material at the current moment, ƒₐᵥ represents an update function of the average lithium concentration of the electrode active material, c_{s,av}(k) represents the average lithium concentration of the electrode active material at the previous moment, c_{s,surf}(k) represents the lithium concentration on the surface of the electrode active material at the previous moment, jₙ(k+1) represents the reaction current intensity at the current moment, θ(k+1) represents the parameter vector at the current moment, Δt represents the sampling interval, c_{s,surf}(k+1) represents the lithium concentration on the surface of the electrode active material at the current moment, ƒ_{surf} represents an update function of the lithium concentration on the surface of the electrode active material, c_{s,av}(k) represents the average lithium concentration of the electrode active material at the previous moment, c_{s,surf}(k) represents the lithium concentration on the surface of the electrode active material at the previous moment, jₙ(k+1) represents the reaction current intensity at the current moment, θ(k+1) represents the parameter vector at the current moment, and Δt represents the sampling interval;
update the lithium concentration of the electrode electrolyte at the current moment based on the lithium concentration of the electrode electrolyte at the previous moment, the current of the port at the previous moment, the parameter vector at the current moment and the sampling interval:

$${c}_{e} ( k + 1 ) = {f}_{e} ( {c}_{e} ( k ) , I ( k ) , θ ( k + 1 ) , Δ t )$$

where cₑ (k+1) represents the lithium concentration of the electrode electrolyte at the current moment, ƒₑ represents an update function of the lithium concentration of the electrode electrolyte, cₑ (k) represents the lithium concentration of the electrode electrolyte at the previous moment, I(k) represents the current of the port at the previous moment, θ(k+1) represents the parameter vector at the current moment, and Δt represents the sampling interval;
obtain a port voltage V of the battery and a potential difference U in the battery at the current moment based on the lithium concentration of the electrode electrolyte at the current moment, the lithium concentration on the surface of the electrode active material at the current moment, the reaction current intensity at the current moment, the parameter vector at the current moment, the temperature of the battery at the previous moment and the current of the port at the previous moment:

$$V ( k + 1 ) = {f}_{V} ( {c}_{e} ( k + 1 ) , {c}_{s , surf} ( k + 1 ) , {j}_{n} ( k + 1 ) , {T}_{b} ( k ) , I ( k ) , θ ( k + 1 ) )$$

$$U ( k + 1 ) = {f}_{U} ( {c}_{e} ( k + 1 ) , {c}_{s , surf} ( k + 1 ) , {j}_{n} ( k + 1 ) , {T}_{b} ( k ) , I ( k ) , θ ( k + 1 ) )$$

where V(k+1) represents the port voltage of the battery at the current moment, ƒᵥ represents an update function of the port voltage of the battery, cₑ (k+1) represents the lithium concentration of the electrode electrolyte at the current moment, c_{s,surf}(k+1) represents the lithium concentration on the surface of the electrode active material at the current moment, jₙ(k+1) represents the reaction current intensity at the current moment, T_{b}(k) represents the temperature of the battery at the previous moment, I(k) represents the current of the port at the previous moment, θ(k+1) represents the parameter vector at the current moment, U(k+1) represents the potential difference in the battery at the current moment, ƒ_{U} represents an update function of the potential difference in the battery, cₑ (k+1) represents the lithium concentration of the electrode electrolyte at the current moment, c_{s,surf}(k+1) represents the lithium concentration on the surface of the electrode active material at the current moment, jₙ(k+1) represents the reaction current intensity at the current moment, T_{b}(k) represents the temperature of the battery at the previous moment, I(k) represents the current of the port at the previous moment, and θ(k+1) represents the parameter vector at the current moment;
obtain the temperature of the battery at the current moment based on the port voltage of the battery at the current moment, the potential difference in the battery at the current moment, the reaction current intensity at the current moment, the parameter vector at the current moment, the temperature of the battery at the previous moment, the ambient temperature at the previous moment, the current of the port at the previous moment and the sampling interval:

$${T}_{b} ( k + 1 ) = {f}_{T} ( V ( k + 1 ) , U ( k + 1 ) , {j}_{n} ( k + 1 ) , {T}_{b} ( k ) , {T}_{a m b} ( k ) , I ( k ) , θ ( k + 1 ) , Δ t )$$

where T_{b} (k+1) represents the temperature of the battery at the current moment, ƒ_{T} represents an update function of the temperature of the battery, V(k+1) represents the port voltage of the battery at the current moment, U(k+1) represents the potential difference in the battery at the current moment, jₙ(k+1) represents the reaction current intensity at the current moment, T_{b} (k) represents the temperature of the battery at the previous moment, T_{amb}(k) represents the ambient temperature at the previous moment, I(k) represents the current of the port at the previous moment, θ(k+1) represents the parameter vector at the current moment, and Δt represents the sampling interval;
define the energy conversion efficiency of the battery based on a charged or discharged state of the battery, the port voltage of the battery at the current moment and the potential difference in the battery at the current moment:

$$\{ \begin{matrix}η ( k ) = \frac{V ( k )}{U ( k )} , I ( k ) \geq 0 \\ η ( k ) = \frac{U ( k )}{V ( k )} , I ( k ) < 0\end{matrix}$$

where η(k) represents the energy conversion efficiency of the battery in the discharged state in the case where I(k)≥0, and η(k) represents the energy conversion efficiency of the battery in the charged state in the case where I(k)<0; and
repeat the above-mentioned simulation, iteration and update steps, and cyclically update a state value at the current moment from a state value at the previous moment: the parameter vector, the reaction current intensity, the potential difference on the surface of the electrode, the lithium concentration of the electrode active material, and the lithium concentration of the electrode electrolyte, and output the port voltage and the energy conversion efficiency of the battery based on a state update result until the preset time period ends to obtain the simulation result of the battery at each moment within the preset time period, where the simulation result of the battery includes: the port voltage of the battery, the average lithium concentration of the electrode active material, the energy conversion efficiency, and the potential difference on the surface of the electrode, and
where the simulation result of the battery is represented as:

$$[ V , {C}_{s} , η , {Φ}_{s e} ] = {f}_{b a t} ( {SOC}_{0} , {T}_{a m b} , I )$$

where V represents the port voltage of the battery at each moment within the preset time period, Cₛ represents the average lithium concentration of the electrode active material at each moment within the preset time period, η represents the energy conversion efficiency at each moment within the preset time period, Φₛₑ represents the potential difference on the surface of the electrode at each moment within the preset time period, f_{bat} represents a set of state update functions, SOC₀ represents the initial state of charge, T_{amb} represents the ambient temperature of the battery, and I represents the amplitude of the constant current sequence of the port.

Further, in embodiments of the present disclosure, the optimizing module 30 is configured to:
set the constraints within the preset time period, define an inequality error for the constraints, and calculate a Sigmoid function value corresponding to the constraints based on the inequality error to obtain a Sigmoid penalty term corresponding to the constraints, where the Sigmoid penalty term approaches 0 in the case where an inequality is established, and the Sigmoid penalty term is a certain larger value in the case where the inequality is not established;
where calculating the Sigmoid function value is represented as:

$${f}_{s i g} = \frac{{M}_{1}}{1 + exp ( - {M}_{2} * E )}$$

where ƒ_{sig} represents a Sigmoid function, M₁ and M₂ each represent any larger constants, E represents the inequality error, and exp represents an exponential function with a natural constant e as a base;
perform iterative optimization to obtain the maximum feasible current value of the port of the battery satisfying the constraints within the preset time period, including:
representing a constrained optimization problem as an unconstrained optimization problem by substituting the Sigmoid penalty term corresponding to the constraints during charging or discharging,
where the unconstrained optimization problem during the discharging is represented as:

$${min}_{I} ( \text{} - I + {f}_{V , min} + {f}_{V , max} + {f}_{c {s}^{-} , min} + {f}_{c {s}^{-} , max} + {f}_{c {s}^{+} , min} + {f}_{c {s}^{+} , max} + {f}_{η , min} + {f}_{ϕ , min} )$$

the unconstrained optimization problem during the charging is represented as:

$${min}_{I} ( \text{} I + {f}_{V , min} + {f}_{V , max} + {f}_{c {s}^{-} , min} + {f}_{c {s}^{-} , max} + {f}_{c {s}^{+} , min} + {f}_{c {s}^{+} , max} + {f}_{η , min} + {f}_{ϕ , min} )$$

where ƒ_{V,min}, ƒ_{V,max}, ƒ_{cs}_{^{−}}_{,min}, ƒ_{cs}_{^{−}}_{,max}, ƒ_{cs}_{⁺}_{,min}, ƒ_{cs}_{⁺}_{,max}, ƒ_{η,min} and ƒ_{ϕ,min} are the Sigmoid penalty terms corresponding to the constraints, I represents the amplitude of the current sequence, and min represents a minimum function, and
where a process of the iterative optimization is solved via an optimization solver by calling an interior point process.

Further, in embodiments of the present disclosure, the calculating module 40 is configured to:
perform the simulation by taking the maximum feasible current value during the charging or discharging as the amplitude of the constant current sequence of the input port of the battery based on the ambient temperature and the initial state of charge of the battery, to obtain the curve of the port voltage of the battery during the charging or discharging within the preset time period; and
obtain an average port voltage during the charging or discharging based on the curve of the port voltage of the battery during the charging or discharging, calculate the maximum output power of the battery during the charging or discharging based on the average port voltage during the charging or discharging and the amplitude of the constant current sequence during the charging or discharging, and obtain the feasible output power value during the charging or discharging corresponding to the ambient temperature and the initial state of charge of the battery,
where the simulations during the charging and discharging are respectively represented as:

$$[ {V}_{dis} , {C}_{s} , η , {Φ}_{s e} ] = {f}_{b a t} ( {SOC}_{0} , {T}_{a m b} , {I}_{max} )$$

$$[ {V}_{char} , {C}_{s} , η , {Φ}_{s e} ] = {f}_{b a t} ( S O {C}_{0} , {T}_{a m b} , {I}_{min} )$$

where V_{dis} represents the curve of the port voltage of the battery during the discharging, V_{char} represents the curve of the port voltage of the battery during the charging, Cₛ represents the average lithium concentration of the electrode active material at each moment within the preset time period, η represents the energy conversion efficiency at each moment within the preset time period, Φₛₑ represents the potential difference on the surface of the electrode at each moment within the preset time period, f_{bat} represents the set of state update functions, SOC₀ represents the initial state of charge, T_{amb} represents the ambient temperature of the battery, Iₘₐₓ represents the maximum feasible current value during the discharging, and Iₘᵢₙ represents the maximum feasible current value during the charging;
the average port voltages during the charging and discharging are respectively represented as:

$${\overline{V}}_{d i s} = \frac{{V}_{d i {s}_{1}} + {V}_{d i {s}_{2}} + … + {V}_{d i {s}_{k}} + … {V}_{d i {s}_{N}}}{N}$$

$${\overline{V}}_{c h a r} = \frac{{V}_{c h a {r}_{1}} + {V}_{c h a {r}_{2}} + … + {V}_{c h a {r}_{k}} + … {V}_{c h a {r}_{N}}}{N}$$

where V̅_{dis} represents the average port voltage during the discharging, V̅_{char} represents the average port voltage during the charging, and N represents a length of the preset time period; and
the feasible output power values during the charging and discharging corresponding to the ambient temperature and the initial state of charge of the battery are respectively represented as:

$${P}_{dis} ( {SOC}_{0} , {T}_{a m b} ) = {I}_{max} ( {SOC}_{0} , {T}_{a m b} ) \times {\overline{V}}_{d i s}$$

$${P}_{char} ( {SOC}_{0} , {T}_{a m b} ) = {I}_{min} ( {SOC}_{0} , {T}_{a m b} ) \times {\overline{V}}_{c h a r}$$

where P_{dis}(SOC₀, T_{amb}) represents the feasible output power value corresponding to the ambient temperature and the initial state of charge of the battery during the discharging, P_{char}(SOC₀, T_{amb}) represents the feasible output power value corresponding to the ambient temperature and the initial state of charge of the battery during the charging, Iₘₐₓ(SOC₀, T_{amb}) represents the maximum feasible current value corresponding to the ambient temperature and the initial state of charge of the battery during the discharging, Iₘᵢₙ(SOC₀, T_{amb}) represents the maximum feasible current value corresponding to the ambient temperature and the initial state of charge of the battery during the charging, V̅_{dis} represents the average port voltage during the discharging, and V̅_{char} represents the average port voltage during the charging.

Further, in embodiments of the present disclosure, the circulating module 50 is configured to adjust the ambient temperature T_{amb} and the initial state of charge SOC₀ of the battery, and to repeat to invoke the obtaining module 10, the processing module 20, the optimizing module 30, and the calculating module 40 to obtain the maximum available power value of the lithium-ion battery during the charging or discharging corresponding to different ambient temperatures and different initial states of charge of the battery, to form a curve of the state of power;
where the curve of the state of power is represented as:

$${P}_{c h a r} ( {SOC}_{0} , {T}_{a m b} ) \leq P ( {SOC}_{0} , {T}_{a m b} ) \leq {P}_{d i s} ( {SOC}_{0} , {T}_{a m b} )$$

where P_{dis}(SOC₀, T_{amb}) represents the feasible output power value corresponding to the ambient temperature and the initial state of charge of the battery during the discharging, P_{char}(SOC₀, T_{amb}) represents the feasible output power value corresponding to the ambient temperature and the initial state of charge of the battery during the charging, and P(SOC₀, T_{amb}) represents an actual power value of the battery.

Further, in embodiments of the present disclosure, the device for estimating the state of power based on the electrochemical model of the lithium-ion battery is further configured to: perform an approximate fitting processing on the state of power by using a piecewise linearization process in an engineering application.

In order to implement the above embodiments, embodiments of the present disclosure further propose a non-transitory computer readable storage medium having stored thereon a computer program, in which when executed by a processor, the computer program is configured to implement the method for estimating the state of power based on the electrochemical model of the lithium-ion battery.

In order to implement the above embodiments, embodiments of the present disclosure further propose an electronic device, including a memory, a processor, and a computer program stored in the memory and executable on the processor, in which when executing the computer program, the processor is configured to implement the method for estimating the state of power based on the electrochemical model of the lithium-ion battery.

In order to implement the above embodiments, embodiments of the present disclosure further propose a computer program product, including a computer program code, in which when running on a computer, the computer program code is configured to implement the method for estimating the state of power based on the electrochemical model of the lithium-ion battery.

In order to implement the above embodiments, embodiments of the present disclosure further propose a computer program, including a computer program code, in which when the computer program code runs on a computer, the computer is configured to implement the method for estimating the state of power based on the electrochemical model of the lithium-ion battery.

It should be noted that foregoing explanation of embodiments of the method for estimating the state of power based on the electrochemical model of the lithium-ion battery is also applicable to the non-transitory computer-readable storage medium, the electronic device, the computer program product, and the computer program in the above embodiments, and will not be repeated here.

Reference throughout this specification to terms such as “an embodiment,” “some embodiments,” “an example,” “a specific example,” or “some examples,” means that a particular feature, structure, material, or characteristic described in connection with the embodiment or example is included in at least one embodiment or example of the present disclosure. Schematic expressions of the above terms throughout this specification are not necessarily referring to the same embodiment or example. Furthermore, the particular features, structures, materials, or characteristics described may be combined in any suitable manner in one or more embodiments or examples. In addition, different embodiments or examples and features of different embodiments or examples described in the specification may be combined by those skilled in the art without mutual contradiction.

In addition, terms such as “first” and “second” are used herein for purposes of description and are not intended to indicate or imply relative importance or implicitly specify the number of technical features indicated. Thus, the feature defined with “first” and “second” may explicitly or implicitly comprise one or more of this feature. In the description of the present disclosure, “a plurality of” means at least two, for example, two or three, unless specified otherwise.

Any process or method described in a flow chart or described herein in other manners may be understood to include one or more modules, segments or portions of codes of executable instructions for achieving specific logical functions or steps in the process, and the scope of a preferred embodiment of the present disclosure includes other implementations, in which the functions may be performed out of the order shown or discussed, including in a substantially simultaneous manner or in a reverse order depending on the functionality involved, which should be understood by those skilled in the art.

The logic and/or step shown in the flow chart or described herein in other manners, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device or equipment and executing the instruction), or to be used in combination with the instruction execution system, device or equipment. As to the specification, “the computer readable medium” may be any device adaptive for including, storing, communicating, propagating or transferring programs to be used by or in combination with the instruction execution system, device or equipment. More specific examples (non-exhaustive list) of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if they are realized by the hardware, likewise in another embodiment, the steps or methods may be realized by any one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

It would be understood by those skilled in the art that all or some of the steps carried by the method in the above-described embodiments may be completed by relevant hardware instructed by a program. The program may be stored in a computer readable storage medium. When the program is executed, one or a combination of the steps of the method in the above-described embodiments may be completed.

In addition, individual functional units in the embodiments of the present disclosure may be integrated in one processing module or may be separately physically present, or two or more units may be integrated in one module. The integrated module as described above may be achieved in the form of hardware, or may be achieved in the form of a software functional module. If the integrated module is achieved in the form of a software functional module and sold or used as a separate product, the integrated module may also be stored in a computer readable storage medium.

The storage medium mentioned above may be read-only memories, magnetic disks, CD, or the like.

Although embodiments of the present disclosure have been shown and described, it would be appreciated by those skilled in the art that the above embodiments are exemplary and cannot be construed to limit the present disclosure, and changes, modifications, alternatives, and variations can be made in the above embodiments without departing from the scope of the present disclosure.

What is claimed is:

1. A method for estimating a state of power based on an electrochemical model of a lithium-ion battery, comprising:
S1: obtaining an ambient temperature and an initial state of charge of the battery;
S2: obtaining state information about the battery, and obtaining a simulation result of the battery at each moment within a preset time period based on the state information about the battery and the electrochemical model of the lithium-ion battery;
S3: obtaining a maximum feasible current value of the battery within the preset time period by iteratively optimizing a simulation process in step S2 with the simulation result of the battery as constraints;
S4: performing simulation by taking the maximum feasible current value as an amplitude of an input constant current sequence of a battery port to obtain a curve of a port voltage of the battery within the preset time period, obtaining maximum output power of the battery based on the curve of the port voltage of the battery and the amplitude of the constant current sequence, and taking the maximum output power of the battery as a maximum available power value corresponding to the ambient temperature and the initial state of charge of the battery; and
S5: adjusting the ambient temperature and the initial state of charge of the battery, and repeating steps S1-S4 to obtain the maximum available power values corresponding to different ambient temperatures and different initial states of charge of the battery to obtain the state of power of the lithium-ion battery.

2. The method of claim 1, wherein the state information about the battery comprises: a lithium concentration on a surface of an electrode active material, an average lithium concentration of the electrode active material, a lithium concentration of an electrode electrolyte, and an initial temperature of the battery; and
the simulation result of the battery comprises: the port voltage of the battery, the average lithium concentration of the electrode active material, an energy conversion efficiency, and a potential difference on a surface of an electrode.

3. The method of claim 2, wherein obtaining the simulation result of the battery at each moment within the preset time period based on the state information about the battery and the simulation with the electrochemical model of the lithium-ion battery comprises:
setting the amplitude of the current sequence of the port of the battery and an amplitude of an ambient temperature sequence to constant values;
at a starting moment of the preset time period, updating a parameter vector at a current moment based on the lithium concentration of the electrode electrolyte, the average lithium concentration of the electrode active material and a temperature of the battery at a previous moment:
$$θ ( k + 1 ) = {f}_{θ} ( {c}_{e} ( k ) , {c}_{s , av} ( k ) , {T}_{b} ( k ) )$$
where θ(k+1) represents the parameter vector at the current moment, ƒ_{θ} represents a parameter update function, cₑ(k) represents the lithium concentration of the electrode electrolyte at the previous moment, c_{s,av}(k) represents the average lithium concentration of the electrode active material at the previous moment, and T_{b} (k) represents the temperature of the battery at the previous moment;
updating a reaction current intensity at the current moment based on the lithium concentration of the electrode electrolyte at the previous moment, the lithium concentration on the surface of the electrode active material at the previous moment, the temperature of the battery at the previous moment, a current of the port at the previous moment and the parameter vector at the current moment:
$${j}_{n} ( k + 1 ) = {f}_{j} ( {c}_{e} ( k ) , {c}_{s , surf} ( k ) , {T}_{b} ( k ) , I ( k ) , θ ( k + 1 ) )$$
where jₙ(k+1) represents the reaction current intensity at the current moment, ƒⱼ represents a reaction current update function, cₑ (k) represents the lithium concentration of the electrode electrolyte at the previous moment, c_{s,surf}(k) represents the lithium concentration on the surface of the electrode active material at the previous moment, T_{b} (k) represents the temperature of the battery at the previous moment, I(k) represents the current of the port at the previous moment, and θ(k+1) represents the parameter vector at the current moment;
updating the potential difference on a solid-solution surface of the electrode at the current moment based on the reaction current intensity and the parameter vector at the current moment:
$${ϕ}_{s e} ( k + 1 ) = {f}_{ϕ} ( {j}_{n} ( k + 1 ) , θ ( k + 1 ) )$$
where ϕₛₑ(k+1) represents the potential difference on the solid-solution surface of the electrode at the current moment, ƒ_{ϕ} represents an update function of the potential difference on the solid-solution surface of the electrode, jₙ(k+1) represents the reaction current intensity at the current moment, and θ(k+1) represents the parameter vector at the current moment;
updating the lithium concentration of the electrode active material at the current moment based on the average lithium concentration of the electrode active material at the previous moment, the lithium concentration on the surface of the electrode active material at the previous moment, the reaction current intensity at the current moment, the parameter vector at the current moment and a sampling interval:
$$\begin{matrix}{c}_{s , av} ( k + 1 ) = {f}_{av} ( {c}_{s , av} ( k ) , {c}_{s , surf} ( k ) , {j}_{n} ( k + 1 ) , θ ( k + 1 ) , Δ t ) \\ {c}_{s , surf} ( k + 1 ) - {f}_{surf} ( {c}_{s , av} ( k ) , {c}_{s , surf} ( k ) , {j}_{n} ( k + 1 ) , θ ( k + 1 ) , Δ t )\end{matrix}$$
where c_{s,av}(k+1) represents the average lithium concentration of the electrode active material at the current moment, ƒₐᵥ represents an update function of the average lithium concentration of the electrode active material, c_{s,av}(k) represents the average lithium concentration of the electrode active material at the previous moment, c_{s,surf} (k) represents the lithium concentration on the surface of the electrode active material at the previous moment, jₙ(k+1) represents the reaction current intensity at the current moment, θ(k+1) represents the parameter vector at the current moment, Δt represents the sampling interval, c_{s,surf} (k+1) represents the lithium concentration on the surface of the electrode active material at the current moment, ƒ_{surf} represents an update function of the lithium concentration on the surface of the electrode active material, c_{s,av}(k) represents the average lithium concentration of the electrode active material at the previous moment, c_{s,surf} (k) represents the lithium concentration on the surface of the electrode active material at the previous moment, jₙ(k+1) represents the reaction current intensity at the current moment, θ(k+1) represents the parameter vector at the current moment, and Δt represents the sampling interval;
updating the lithium concentration of the electrode electrolyte at the current moment based on the lithium concentration of the electrode electrolyte at the previous moment, the current of the port at the previous moment, the parameter vector at the current moment and the sampling interval:
$${c}_{e} ( k + 1 ) = {f}_{e} ( {c}_{e} ( k ) , I ( k ) , θ ( k + 1 ) , Δ t )$$
where cₑ (k+1) represents the lithium concentration of the electrode electrolyte at the current moment, ƒₑ represents an update function of the lithium concentration of the electrode electrolyte, cₑ (k) represents the lithium concentration of the electrode electrolyte at the previous moment, I(k) represents the current of the port at the previous moment, θ(k+1) represents the parameter vector at the current moment, and Δt represents the sampling interval;
obtaining a port voltage V of the battery and a potential difference U in the battery at the current moment based on the lithium concentration of the electrode electrolyte at the current moment, the lithium concentration on the surface of the electrode active material at the current moment, the reaction current intensity at the current moment, the parameter vector at the current moment, the temperature of the battery at the previous moment and the current of the port at the previous moment:
$$\begin{matrix}V ( k + 1 ) = {f}_{V} ( {c}_{e} ( k + 1 ) , {c}_{s , surf} ( k + 1 ) , {j}_{n} ( k + 1 ) , {T}_{b} ( k ) , I ( k ) , θ ( k + 1 ) ) \\ U ( k + 1 ) = {f}_{U} ( {c}_{e} ( k + 1 ) , {c}_{s , surf} ( k + 1 ) , {j}_{n} ( k + 1 ) , {T}_{b} ( k ) , I ( k ) , θ ( k + 1 ) )\end{matrix}$$
where V(k+1) represents the port voltage of the battery at the current moment, ƒᵥ represents an update function of the port voltage of the battery, cₑ (k+1) represents the lithium concentration of the electrode electrolyte at the current moment, c_{s,surf}(k+1) represents the lithium concentration on the surface of the electrode active material at the current moment, jₙ(k+1) represents the reaction current intensity at the current moment, T_{b}(k) represents the temperature of the battery at the previous moment, I(k) represents the current of the port at the previous moment, θ(k+1) represents the parameter vector at the current moment, U(k+1) represents the potential difference in the battery at the current moment, ƒ_{U} represents an update function of the potential difference in the battery, cₑ (k+1) represents the lithium concentration of the electrode electrolyte at the current moment, c_{s,surf}(k+1) represents the lithium concentration on the surface of the electrode active material at the current moment, jₙ(k+1) represents the reaction current intensity at the current moment, T_{b}(k) represents the temperature of the battery at the previous moment, I(k) represents the current of the port at the previous moment, and θ(k+1) represents the parameter vector at the current moment;
obtaining the temperature of the battery at the current moment based on the port voltage of the battery at the current moment, the potential difference in the battery at the current moment, the reaction current intensity at the current moment, the parameter vector at the current moment, the temperature of the battery at the previous moment, the ambient temperature at the previous moment, the current of the port at the previous moment and the sampling interval:
$${T}_{b} ( k + 1 ) = {f}_{T} ( V ( k + 1 ) , U ( k + 1 ) , {j}_{n} ( k + 1 ) , {T}_{b} ( k ) , {T}_{amb} ( k ) , I ( k ) , θ ( k + 1 ) , Δ t )$$
where T_{b}(k+1) represents the temperature of the battery at the current moment, ƒ_{T} represents an update function of the temperature of the battery, V(k+1) represents the port voltage of the battery at the current moment, U(k+1) represents the potential difference in the battery at the current moment, jₙ(k+1) represents the reaction current intensity at the current moment, T_{b}(k) represents the temperature of the battery at the previous moment, T_{amb}(k) represents the ambient temperature at the previous moment, I(k) represents the current of the port at the previous moment, θ(k+1) represents the parameter vector at the current moment, and Δt represents the sampling interval;
defining the energy conversion efficiency of the battery based on a charged or discharged state of the battery, the port voltage of the battery at the previous moment and the potential difference in the battery at the previous moment:
$$\{ \begin{matrix}η ( k ) = \frac{V ( k )}{U ( k )} , I ( k ) \geq 0 \\ η ( k ) = \frac{U ( k )}{V ( k )} , I ( k ) < 0\end{matrix}$$
where η(k) represents the energy conversion efficiency of the battery in the discharged state in a case where I(k)≥0, and η(k) represents the energy conversion efficiency of the battery in the charged state in a case where I(k)≤0;
repeating the above-mentioned simulation, iteration and update steps, and cyclically updating a state value at the current moment from a state value at the previous moment: the parameter vector, the reaction current intensity, the potential difference on the surface of the electrode, the lithium concentration of the electrode active material, and the lithium concentration of the electrode electrolyte, and outputting the port voltage and the energy conversion efficiency of the battery based on a state update result until the preset time period ends to obtain the simulation result of the battery at each moment within the preset time period, wherein the simulation result of the battery comprises: the port voltage of the battery, the average lithium concentration of the electrode active material, the energy conversion efficiency, and the potential difference on the surface of the electrode, and
wherein the simulation result of the battery is represented as:
$$[ V , {C}_{s} , η , {Φ}_{SE} ] = {f}_{bat} ( {SOC}_{0} , {T}_{amb} , I )$$
where V represents the port voltage of the battery at each moment within the preset time period, Cₛ represents the average lithium concentration of the electrode active material at each moment within the preset time period, η represents the energy conversion efficiency at each moment within the preset time period, Φₛₑ represents the potential difference on the surface of the electrode at each moment within the preset time period, f_{bat} represents a set of state update functions, SOC₀ represents the initial state of charge, T_{amb} represents the ambient temperature of the battery, and I represents the amplitude of the constant current sequence of the port.

4. The method of claim 1, wherein obtaining the maximum feasible current value of the port of the battery within the preset time period by iteratively optimizing the simulation process in step S2 with the simulation result of the battery as the constraints comprises:
setting the constraints within the preset time period, defining an inequality error for the constraints, and calculating a Sigmoid function value corresponding to the constraints based on the inequality error to obtain a Sigmoid penalty term corresponding to the constraints, wherein the Sigmoid penalty term approaches 0 in a case where an inequality is established, and the Sigmoid penalty term is a certain larger value in a case where the inequality is not established;
wherein calculating the Sigmoid function value is represented as:
$${f}_{sig} = \frac{{M}_{1}}{1 + exp ( - {M}_{2} * E )}$$
where ƒ_{sig} represents a Sigmoid function, M₁ and M₂ each represent any larger constants, E represents the inequality error, and exp represents an exponential function with a natural constant e as a base;
performing iterative optimization to obtain the maximum feasible current value of the port of the battery satisfying the constraints within the preset time period, comprising:
representing a constrained optimization problem as an unconstrained optimization problem by substituting the Sigmoid penalty term corresponding to the constraints during charging or discharging,
wherein the unconstrained optimization problem during the discharging is represented as:
$${min}_{I} ( - I + {f}_{V , min} + {f}_{V , max} + {f}_{c {s}^{-} , min} +$$
$${f}_{c {s}^{-} , max} + {f}_{c {s}^{+} , min} + {f}_{c {s}^{+} , max} + {f}_{η , min} + {f}_{ϕ , min} )$$
the unconstrained optimization problem during the charging is represented as:
$${min}_{I} ( I + {f}_{V , min} + {f}_{V , max} + {f}_{c {s}^{-} , min} + {f}_{c {s}^{-} , max} +$$
$${f}_{c {s}^{+} , min} + {f}_{c {s}^{+} , max} + {f}_{η , min} + {f}_{ϕ , min} )$$
where ƒ_{V,min}, ƒ_{V,max}, ƒ_{cs}_{^{−}}_{,min}, ƒ_{cs}_{^{−}}_{,max}, ƒ_{cs}_{⁺}_{,min}, ƒ_{cs}_{⁺}_{,max}, ƒ_{η,min} and ƒ_{ϕ,min} are the Sigmoid penalty terms corresponding to the constraints, I represents the amplitude of the current sequence, and min represents a minimum function, and
wherein a process of the iterative optimization is solved via an optimization solver by calling an interior point process.

5. The method of claim 1, wherein performing the simulation by taking the maximum feasible current value as the amplitude of the constant current sequence of the input port of the battery to obtain the curve of the port voltage of the battery within the preset time period, obtaining the maximum output power of the battery based on the curve of the port voltage of the battery and the amplitude of the constant current sequence, and taking the maximum output power of the battery as the maximum available power value corresponding to the ambient temperature and the initial state of charge of the battery comprise:
performing the simulation by taking the maximum feasible current value during the charging or discharging as the amplitude of the constant current sequence of the input port of the battery based on the ambient temperature and the initial state of charge of the battery, to obtain the curve of the port voltage of the battery during the charging or discharging within the preset time period;
obtaining an average port voltage during the charging or discharging based on the curve of the port voltage of the battery during the charging or discharging, calculating the maximum output power of the battery during the charging or discharging based on the average port voltage during the charging or discharging and the amplitude of the constant current sequence during the charging or discharging, and obtaining the feasible output power value during the charging or discharging corresponding to the ambient temperature and the initial state of charge of the battery, wherein:
the simulations during the charging and discharging are respectively represented as:
$$\begin{matrix}[ {V}_{dis} , {C}_{s} , η , {Φ}_{se} ] = {f}_{bat} ( {SOC}_{0} , {T}_{amb} , {I}_{max} ) \\ [ {V}_{char} , {C}_{s} , η , {Φ}_{se} ] = {f}_{bat} ( {SOC}_{0} , {T}_{amb} , {I}_{min} )\end{matrix}$$
where V_{dis} represents the curve of the port voltage of the battery during the discharging, V_{char} represents the curve of the port voltage of the battery during the charging, Cₛ represents the average lithium concentration of the electrode active material at each moment within the preset time period, η represents the energy conversion efficiency at each moment within the preset time period, Φₛₑ represents the potential difference on the surface of the electrode at each moment within the preset time period, f_{bat} represents the set of state update functions, SOC₀ represents the initial state of charge, T_{amb} represents the ambient temperature of the battery, Iₘₐₓ represents the maximum feasible current value during the discharging, and Iₘᵢₙ represents the maximum feasible current value during the charging;
the average port voltages during the charging and discharging are respectively represented as:
$$\begin{matrix}{\overline{V}}_{dis} = \frac{{V}_{{dis}_{1}} + {V}_{{dis}_{2}} + … + {V}_{{dis}_{k}} + … {V}_{{dis}_{N}}}{N} \\ {\overline{V}}_{char} = \frac{{V}_{{char}_{1}} + {V}_{{char}_{2}} + … + {V}_{{char}_{k}} + … {V}_{{char}_{N}}}{N}\end{matrix}$$
where V̅_{dis} represents the average port voltage during the discharging, V̅_{char} represents the average port voltage during the charging, and N represents a length of the preset time period;
the feasible output power values during the charging and discharging corresponding to the ambient temperature and the initial state of charge of the battery are respectively represented as:
$$\begin{matrix}{P}_{dis} ( {SOC}_{0} , {T}_{amb} ) = {I}_{max} ( {SOC}_{0} , {T}_{amb} ) \times {\overline{V}}_{dis} \\ {P}_{char} ( {SOC}_{0} , {T}_{a m b} ) = {I}_{min} ( {SOC}_{0} , {T}_{amb} ) \times {\overline{V}}_{char}\end{matrix}$$
where P_{dis}(SOC₀, T_{amb}) represents the feasible output power value corresponding to the ambient temperature and the initial state of charge of the battery during the discharging, P_{char}(SOC₀, T_{amb}) represents the feasible output power value corresponding to the ambient temperature and the initial state of charge of the battery during the charging, Iₘₐₓ(SOC₀, T_{amb}) represents the maximum feasible current value corresponding to the ambient temperature and the initial state of charge of the battery during the discharging, Iₘᵢₙ(SOC₀, T_{amb}) represents the maximum feasible current value corresponding to the ambient temperature and the initial state of charge of the battery during the charging, V̅_{dis} represents the average port voltage during the discharging, and V̅_{char} represents the average port voltage during the charging.

6. The method of claim 1, wherein adjusting the ambient temperature and the initial state of charge of the battery, and repeating steps S1-S4 to obtain the maximum available power values corresponding to different ambient temperatures and different initial states of charge of the battery to obtain the state of power of the lithium-ion battery comprise:
adjusting the ambient temperature T_{amb} and the initial state of charge SOC₀ of the battery, and repeating steps S1-S4 to obtain the maximum available power value of the lithium-ion battery during the charging or discharging corresponding to different ambient temperatures and different initial states of charge of the battery, to form a curve of the state of power;
wherein the curve of the state of power is represented as:
$${P}_{char} ( {SOC}_{0} , {T}_{amb} ) \leq P ( {SOC}_{0} , {T}_{amb} ) \leq {P}_{dis} ( {SOC}_{0} , {T}_{amb} )$$
where P_{dis}(SOC₀, T_{amb}) represents the feasible output power value corresponding to the ambient temperature and the initial state of charge of the battery during the discharging, P_{char}(SOC₀, T_{amb}) represents the feasible output power value corresponding to the ambient temperature and the initial state of charge of the battery during the charging, and P(SOC₀, T_{amb}) represents an actual power value of the battery.

7. The method of claim 1, further comprising:
performing an approximate fitting processing on the state of power by using a piecewise linearization process in an engineering application.

8. A non-transitory computer readable storage medium storing a computer program, which, when executed by a processor, the processor is configured to:
obtain an ambient temperature and an initial state of charge of a battery;
obtain state information about the battery, and obtain a simulation result of the battery at each moment within a preset time period based on the state information about the battery and an electrochemical model of a lithium-ion battery;
obtain a maximum feasible current value of the battery within the preset time period by iteratively optimizing a simulation process with the simulation result of the battery as constraints;
perform simulation by taking the maximum feasible current value as an amplitude of an input constant current sequence of a battery port to obtain a curve of a port voltage of the battery within the preset time period, obtain maximum output power of the battery based on the curve of the port voltage of the battery and the amplitude of the constant current sequence, and take the maximum output power of the battery as a maximum available power value corresponding to the ambient temperature and the initial state of charge of the battery; and
adjust the ambient temperature and the initial state of charge of the battery, and repeat the above steps to obtain the maximum available power values corresponding to different ambient temperatures and different initial states of charge of the battery to obtain the state of power of the lithium-ion battery.

9. The non-transitory computer readable storage medium of claim 8, wherein the state information about the battery comprises: a lithium concentration on a surface of an electrode active material, an average lithium concentration of the electrode active material, a lithium concentration of an electrode electrolyte, and an initial temperature of the battery; and
the simulation result of the battery comprises: the port voltage of the battery, the average lithium concentration of the electrode active material, an energy conversion efficiency, and a potential difference on a surface of an electrode.

10. The non-transitory computer readable storage medium of claim 9, wherein the processor is configured to:
set the amplitude of the current sequence of the port of the battery and an amplitude of an ambient temperature sequence to constant values;
at a starting moment of the preset time period, update a parameter vector at a current moment based on the lithium concentration of the electrode electrolyte, the average lithium concentration of the electrode active material and a temperature of the battery at a previous moment:
$$θ ( k + 1 ) = {f}_{θ} ( {c}_{e} ( k ) , {c}_{{s}_{av}} ( k ) , {T}_{b} ( k ) )$$
where θ(k+1) represents the parameter vector at the current moment, ƒ_{θ} represents a parameter update function, cₑ(k) represents the lithium concentration of the electrode electrolyte at the previous moment, c_{s,av}(k) represents the average lithium concentration of the electrode active material at the previous moment, and T_{b} (k) represents the temperature of the battery at the previous moment;
update a reaction current intensity at the current moment based on the lithium concentration of the electrode electrolyte at the previous moment, the lithium concentration on the surface of the electrode active material at the previous moment, the temperature of the battery at the previous moment, a current of the port at the previous moment and the parameter vector at the current moment:
$${j}_{n} ( k + 1 ) = {f}_{j} ( {c}_{e} ( k ) , {c}_{s , surf} ( k ) , {T}_{b} ( k ) , I ( k ) , θ ( k + 1 ) )$$
where jₙ(k+1) represents the reaction current intensity at the current moment, ƒⱼ represents a reaction current update function, cₑ (k) represents the lithium concentration of the electrode electrolyte at the previous moment, c_{s,surf}(k) represents the lithium concentration on the surface of the electrode active material at the previous moment, T_{b} (k) represents the temperature of the battery at the previous moment, I(k) represents the current of the port at the previous moment, and θ(k+1) represents the parameter vector at the current moment;
update the potential difference on a solid-solution surface of the electrode at the current moment based on the reaction current intensity and the parameter vector at the current moment:
$${ϕ}_{s e} ( k + 1 ) = {f}_{ϕ} ( {j}_{n} ( k + 1 ) , θ ( k + 1 ) )$$
where ϕₛₑ (k+1) represents the potential difference on the solid-solution surface of the electrode at the current moment, ƒ_{ϕ} represents an update function of the potential difference on the solid-solution surface of the electrode, jₙ(k+1) represents the reaction current intensity at the current moment, and θ(k+1) represents the parameter vector at the current moment;
update the lithium concentration of the electrode active material at the current moment based on the average lithium concentration of the electrode active material at the previous moment, the lithium concentration on the surface of the electrode active material at the previous moment, the reaction current intensity at the current moment, the parameter vector at the current moment and a sampling interval:
$${c}_{s , av} ( k + 1 ) = {f}_{a v} ( {c}_{s , av} ( k ) , {c}_{s , surf} ( k ) , {j}_{n} ( k + 1 ) , θ ( k + 1 ) , Δ t )$$
$${c}_{s , surf} ( k + 1 ) = {f}_{surf} ( {c}_{s , av} ( k ) , {c}_{s , surf} ( k ) , {j}_{n} ( k + 1 ) , θ ( k + 1 ) , Δ t )$$
where c_{s,av}(k+1) represents the average lithium concentration of the electrode active material at the current moment, ƒₐᵥ represents an update function of the average lithium concentration of the electrode active material, c_{s,av}(k) represents the average lithium concentration of the electrode active material at the previous moment, C_{s,surf} (k) represents the lithium concentration on the surface of the electrode active material at the previous moment, jₙ(k+1) represents the reaction current intensity at the current moment, θ(k+1) represents the parameter vector at the current moment, Δt represents the sampling interval, C_{s,surf} (k+1) represents the lithium concentration on the surface of the electrode active material at the current moment, ƒ_{surf} represents an update function of the lithium concentration on the surface of the electrode active material, c_{s,av}(k) represents the average lithium concentration of the electrode active material at the previous moment, c_{s,surf} (k) represents the lithium concentration on the surface of the electrode active material at the previous moment, jₙ(k+1) represents the reaction current intensity at the current moment, θ(k+1) represents the parameter vector at the current moment, and Δt represents the sampling interval;
update the lithium concentration of the electrode electrolyte at the current moment based on the lithium concentration of the electrode electrolyte at the previous moment, the current of the port at the previous moment, the parameter vector at the current moment and the sampling interval:
$${c}_{e} ( k + 1 ) = {f}_{e} ( {c}_{e} ( k ) , I ( k ) , θ ( k + 1 ) , Δ t )$$
where cₑ(k+1) represents the lithium concentration of the electrode electrolyte at the current moment, ƒₑ represents an update function of the lithium concentration of the electrode electrolyte, cₑ(k) represents the lithium concentration of the electrode electrolyte at the previous moment, I(k) represents the current of the port at the previous moment, θ(k+1) represents the parameter vector at the current moment, and Δt represents the sampling interval;
obtain a port voltage V of the battery and a potential difference U in the battery at the current moment based on the lithium concentration of the electrode electrolyte at the current moment, the lithium concentration on the surface of the electrode active material at the current moment, the reaction current intensity at the current moment, the parameter vector at the current moment, the temperature of the battery at the previous moment and the current of the port at the previous moment:
$$V ( k + 1 ) = {f}_{V} ( {c}_{e} ( k + 1 ) , {c}_{s , surf} ( k + 1 ) , {j}_{n} ( k + 1 ) , {T}_{b} ( k ) , I ( k ) , θ ( k + 1 ) )$$
$$U ( k + 1 ) = {f}_{U} ( {c}_{e} ( k + 1 ) , {c}_{s , surf} ( k + 1 ) , {j}_{n} ( k + 1 ) , {T}_{b} ( k ) , I ( k ) , θ ( k + 1 ) )$$
where V(k+1) represents the port voltage of the battery at the current moment, ƒᵥ represents an update function of the port voltage of the battery, cₑ(k+1) represents the lithium concentration of the electrode electrolyte at the current moment, c_{s,surf}(k+1) represents the lithium concentration on the surface of the electrode active material at the current moment, jₙ(k+1) represents the reaction current intensity at the current moment, T_{b}(k) represents the temperature of the battery at the previous moment, I(k) represents the current of the port at the previous moment, θ(k+1) represents the parameter vector at the current moment, U(k+1) represents the potential difference in the battery at the current moment, ƒ_{U} represents an update function of the potential difference in the battery, cₑ (k+1) represents the lithium concentration of the electrode electrolyte at the current moment, c_{s,surf}(k+1) represents the lithium concentration on the surface of the electrode active material at the current moment, jₙ(k+1) represents the reaction current intensity at the current moment, T_{b}(k) represents the temperature of the battery at the previous moment, I(k) represents the current of the port at the previous moment, and θ(k+1) represents the parameter vector at the current moment;
obtain the temperature of the battery at the current moment based on the port voltage of the battery at the current moment, the potential difference in the battery at the current moment, the reaction current intensity at the current moment, the parameter vector at the current moment, the temperature of the battery at the previous moment, the ambient temperature at the previous moment, the current of the port at the previous moment and the sampling interval:
$${T}_{b} ( k + 1 ) = {f}_{T} ( V ( k + 1 ) , U ( k + 1 ) , {j}_{n} ( k + 1 ) , {T}_{b} ( k ) , {T}_{a m b} ( k ) , I ( k ) , θ ( k + 1 ) , Δ t )$$
where T_{b}(k+1) represents the temperature of the battery at the current moment, ƒ_{T} represents an update function of the temperature of the battery, V(k+1) represents the port voltage of the battery at the current moment, U(k+1) represents the potential difference in the battery at the current moment, jₙ(k+1) represents the reaction current intensity at the current moment, T_{b}(k) represents the temperature of the battery at the previous moment, T_{amb}(k) represents the ambient temperature at the previous moment, I(k) represents the current of the port at the previous moment, θ(k+1) represents the parameter vector at the current moment, and Δt represents the sampling interval;
define the energy conversion efficiency of the battery based on a charged or discharged state of the battery, the port voltage of the battery at the previous moment and the potential difference in the battery at the previous moment:
$$\{ \begin{matrix}η ( k ) = \frac{V ( k )}{U ( k )} , I ( k ) \geq 0 \\ η ( k ) = \frac{U ( k )}{V ( k )} , I ( k ) < 0\end{matrix}$$
where η(k) represents the energy conversion efficiency of the battery in the discharged state in a case where I(k)≥0, and η(k) represents the energy conversion efficiency of the battery in the charged state in a case where I(k)<0;
repeat the above-mentioned simulation, iteration and update steps, and cyclically updating a state value at the current moment from a state value at the previous moment: the parameter vector, the reaction current intensity, the potential difference on the surface of the electrode, the lithium concentration of the electrode active material, and the lithium concentration of the electrode electrolyte, and outputting the port voltage and the energy conversion efficiency of the battery based on a state update result until the preset time period ends to obtain the simulation result of the battery at each moment within the preset time period, wherein the simulation result of the battery comprises: the port voltage of the battery, the average lithium concentration of the electrode active material, the energy conversion efficiency, and the potential difference on the surface of the electrode, and
wherein the simulation result of the battery is represented as:
$$[ V , {C}_{s} , η , {Φ}_{s e} ] = {f}_{b a t} ( {SOC}_{0} , {T}_{a m b} , I )$$
where V represents the port voltage of the battery at each moment within the preset time period, Cₛ represents the average lithium concentration of the electrode active material at each moment within the preset time period, η represents the energy conversion efficiency at each moment within the preset time period, Φₛₑ represents the potential difference on the surface of the electrode at each moment within the preset time period, f_{bat} represents a set of state update functions, SOC₀ represents the initial state of charge, T_{amb} represents the ambient temperature of the battery, and I represents the amplitude of the constant current sequence of the port.

11. The non-transitory computer readable storage medium of claim 8, wherein the processor is configured to:
set the constraints within the preset time period, defining an inequality error for the constraints, and calculate a Sigmoid function value corresponding to the constraints based on the inequality error to obtain a Sigmoid penalty term corresponding to the constraints, wherein the Sigmoid penalty term approaches 0 in a case where an inequality is established, and the Sigmoid penalty term is a certain larger value in a case where the inequality is not established;
wherein calculating the Sigmoid function value is represented as:
$${f}_{s i g} = \frac{{M}_{1}}{1 + exp ( - {M}_{2} * E )}$$
where ƒ_{sig} represents a Sigmoid function, M₁ and M₂ each represent any larger constants, E represents the inequality error, and exp represents an exponential function with a natural constant e as a base;
perform iterative optimization to obtain the maximum feasible current value of the port of the battery satisfying the constraints within the preset time period, comprising:
represent a constrained optimization problem as an unconstrained optimization problem by substituting the Sigmoid penalty term corresponding to the constraints during charging or discharging,
wherein the unconstrained optimization problem during the discharging is represented as:
$${min}_{I} ( - I + {f}_{V , min} + {f}_{V , max} + {f}_{c {s}^{-} , min} + {f}_{c {s}^{-} , max} + \\ {f}_{c {s}^{+} , min} + {f}_{c {s}^{+} , max} + {f}_{η , min} + {f}_{ϕ , min} )$$
the unconstrained optimization problem during the charging is represented as:
$${min}_{1} ( I + {f}_{V , min} + {f}_{V , max} + {f}_{c {s}^{-} , min} + {f}_{c {s}^{-} , max} + \\ {f}_{c {s}^{+} , min} + {f}_{c {s}^{+} , max} + {f}_{η , min} + {f}_{ϕ , min} )$$
where ƒ_{V,min}, ƒ_{V,max}, ƒ_{cs}_{^{−}}_{,min}, ƒ_{cs}_{^{−}}_{,max}, ƒ_{cs}_{⁺}_{,min}, ƒ_{cs}_{⁺}_{,max}, ƒ_{η,min} and ƒ_{ϕ,min} are the Sigmoid penalty terms corresponding to the constraints, I represents the amplitude of the current sequence, and min represents a minimum function, and
wherein a process of the iterative optimization is solved via an optimization solver by calling an interior point process.

12. The non-transitory computer readable storage medium of claim 8, wherein the processor is configured to:
perform the simulation by taking the maximum feasible current value during the charging or discharging as the amplitude of the constant current sequence of the input port of the battery based on the ambient temperature and the initial state of charge of the battery, to obtain the curve of the port voltage of the battery during the charging or discharging within the preset time period;
obtain an average port voltage during the charging or discharging based on the curve of the port voltage of the battery during the charging or discharging, calculate the maximum output power of the battery during the charging or discharging based on the average port voltage during the charging or discharging and the amplitude of the constant current sequence during the charging or discharging, and obtain the feasible output power value during the charging or discharging corresponding to the ambient temperature and the initial state of charge of the battery, wherein:
the simulations during the charging and discharging are respectively represented as:
$$[ {V}_{d i s} , {C}_{s} , η , {Φ}_{s e} ] = {f}_{b a t} ( {SOC}_{0} , {T}_{a m b} , {I}_{max} )$$
$$[ {V}_{c h a r} , {C}_{s} , η , {Φ}_{s e} ] = {f}_{b a t} ( {SOC}_{0} , {T}_{a m b} , {I}_{min} )$$
where V_{dis} represents the curve of the port voltage of the battery during the discharging, V_{char} represents the curve of the port voltage of the battery during the charging, Cₛ represents the average lithium concentration of the electrode active material at each moment within the preset time period, η represents the energy conversion efficiency at each moment within the preset time period, Φₛₑ represents the potential difference on the surface of the electrode at each moment within the preset time period, f_{bat} represents the set of state update functions, SOC₀ represents the initial state of charge, T_{amb} represents the ambient temperature of the battery, Iₘₐₓ represents the maximum feasible current value during the discharging, and Iₘᵢₙ represents the maximum feasible current value during the charging;
the average port voltages during the charging and discharging are respectively represented as:
$${\overline{V}}_{d i s} = \frac{{V}_{d i {s}_{1}} + {V}_{d i {s}_{2}} + … + {V}_{d i {s}_{k}} + … {V}_{d i {s}_{N}}}{N} {\overline{V}}_{c h a r} = \frac{{V}_{c h a {r}_{1}} + {V}_{c h a {r}_{2}} + … + {V}_{c h a {r}_{k}} + … {V}_{c h a {r}_{N}}}{N}$$
where V̅_{dis} represents the average port voltage during the discharging, V̅_{char} represents the average port voltage during the charging, and N represents a length of the preset time period;
the feasible output power values during the charging and discharging corresponding to the ambient temperature and the initial state of charge of the battery are respectively represented as:
$${P}_{d i s} ( {SOC}_{0} , {T}_{a m b} ) = {I}_{max} ( {SOC}_{0} , {T}_{a m b} ) \times {\overline{V}}_{d i s}$$
$${P}_{c h a r} ( {SOC}_{0} , {T}_{a m b} ) = {I}_{min} ( {SOC}_{0} , {T}_{a m b} ) \times {\overline{V}}_{c h a r}$$
where P_{dis}(SOC₀, T_{amb}) represents the feasible output power value corresponding to the ambient temperature and the initial state of charge of the battery during the discharging, P_{char}(SOC₀, T_{amb}) represents the feasible output power value corresponding to the ambient temperature and the initial state of charge of the battery during the charging, Iₘₐₓ(SOC₀, T_{amb}) represents the maximum feasible current value corresponding to the ambient temperature and the initial state of charge of the battery during the discharging, Iₘᵢₙ(SOC₀, T_{amb}) represents the maximum feasible current value corresponding to the ambient temperature and the initial state of charge of the battery during the charging, V̅_{dis} represents the average port voltage during the discharging, and V̅_{char} represents the average port voltage during the charging.

13. The non-transitory computer readable storage medium of claim 8, wherein the processor is configured to:
adjust the ambient temperature T_{amb} and the initial state of charge SOC₀ of the battery, and repeat the above steps to obtain the maximum available power value of the lithium-ion battery during the charging or discharging corresponding to different ambient temperatures and different initial states of charge of the battery, to form a curve of the state of power;
wherein the curve of the state of power is represented as:
$${P}_{c h a r} ( {SOC}_{0} , {T}_{a m b} ) \leq P ( {SOC}_{0} , {T}_{a m b} ) \leq {P}_{d i s} ( {SOC}_{0} , {T}_{a m b} )$$
where P_{dis}(SOC₀, T_{amb}) represents the feasible output power value corresponding to the ambient temperature and the initial state of charge of the battery during the discharging, P_{char}(SOC₀, T_{amb}) represents the feasible output power value corresponding to the ambient temperature and the initial state of charge of the battery during the charging, and P(SOC₀, T_{amb}) represents an actual power value of the battery.

14. An electronic device, comprising:
a memory; and
a processor storing a computer program, which, when executed by the processor, the processor is configured to:
obtain an ambient temperature and an initial state of charge of a battery;
obtain state information about the battery, and obtain a simulation result of the battery at each moment within a preset time period based on the state information about the battery and an electrochemical model of a lithium-ion battery;
obtain a maximum feasible current value of the battery within the preset time period by iteratively optimizing a simulation process with the simulation result of the battery as constraints;
perform simulation by taking the maximum feasible current value as an amplitude of an input constant current sequence of a battery port to obtain a curve of a port voltage of the battery within the preset time period, obtain maximum output power of the battery based on the curve of the port voltage of the battery and the amplitude of the constant current sequence, and take the maximum output power of the battery as a maximum available power value corresponding to the ambient temperature and the initial state of charge of the battery; and
adjust the ambient temperature and the initial state of charge of the battery, and repeat the above steps to obtain the maximum available power values corresponding to different ambient temperatures and different initial states of charge of the battery to obtain the state of power of the lithium-ion battery.

15. The electronic device of claim 14, wherein the state information about the battery comprises: a lithium concentration on a surface of an electrode active material, an average lithium concentration of the electrode active material, a lithium concentration of an electrode electrolyte, and an initial temperature of the battery; and
the simulation result of the battery comprises: the port voltage of the battery, the average lithium concentration of the electrode active material, an energy conversion efficiency, and a potential difference on a surface of an electrode.

16. The electronic device of claim 15, wherein the processor is configured to:
set the amplitude of the current sequence of the port of the battery and an amplitude of an ambient temperature sequence to constant values;
at a starting moment of the preset time period, update a parameter vector at a current moment based on the lithium concentration of the electrode electrolyte, the average lithium concentration of the electrode active material and a temperature of the battery at a previous moment:
$$θ ( k + 1 ) = {f}_{θ} ( {c}_{e} ( k ) , {c}_{s , av} ( k ) , {T}_{b} ( k ) )$$
where θ(k+1) represents the parameter vector at the current moment, ƒ_{θ} represents a parameter update function, cₑ(k) represents the lithium concentration of the electrode electrolyte at the previous moment, c_{s,av}(k) represents the average lithium concentration of the electrode active material at the previous moment, and T_{b} (k) represents the temperature of the battery at the previous moment;
update a reaction current intensity at the current moment based on the lithium concentration of the electrode electrolyte at the previous moment, the lithium concentration on the surface of the electrode active material at the previous moment, the temperature of the battery at the previous moment, a current of the port at the previous moment and the parameter vector at the current moment:
$${j}_{n} ( k + 1 ) = {f}_{j} ( {c}_{e} ( k ) , {c}_{s , surf} ( k ) , {T}_{b} ( k ) , I ( k ) , θ ( k + 1 ) )$$
where jₙ(k+1) represents the reaction current intensity at the current moment, ƒⱼ represents a reaction current update function, cₑ (k) represents the lithium concentration of the electrode electrolyte at the previous moment, C_{s,surf}(k) represents the lithium concentration on the surface of the electrode active material at the previous moment, T_{b} (k) represents the temperature of the battery at the previous moment, I(k) represents the current of the port at the previous moment, and θ(k+1) represents the parameter vector at the current moment;
update the potential difference on a solid-solution surface of the electrode at the current moment based on the reaction current intensity and the parameter vector at the current moment:
$${ϕ}_{se} ( k + 1 ) = {f}_{ϕ} ( {j}_{n} ( k + 1 ) , θ ( k + 1 ) )$$
where ϕₛₑ (k+1) represents the potential difference on the solid-solution surface of the electrode at the current moment, ƒ_{ϕ} represents an update function of the potential difference on the solid-solution surface of the electrode, jₙ(k+1) represents the reaction current intensity at the current moment, and θ(k+1) represents the parameter vector at the current moment;
update the lithium concentration of the electrode active material at the current moment based on the average lithium concentration of the electrode active material at the previous moment, the lithium concentration on the surface of the electrode active material at the previous moment, the reaction current intensity at the current moment, the parameter vector at the current moment and a sampling interval:
$${c}_{s , av} ( k + 1 ) = {f}_{av} ( {c}_{s , av} ( k ) , {c}_{s , surf} ( k ) , {j}_{n} ( k + 1 ) , θ ( k + 1 ) , Δ t ) \\ {c}_{s , surf} ( k + 1 ) = {f}_{surf} ( {c}_{s , av} ( k ) , {c}_{s , surf} ( k ) , {j}_{n} ( k + 1 ) , θ ( k + 1 ) , Δ t )$$
where c_{s,av}(k+1) represents the average lithium concentration of the electrode active material at the current moment, ƒₐᵥ represents an update function of the average lithium concentration of the electrode active material, c_{s,av}(k) represents the average lithium concentration of the electrode active material at the previous moment, C_{s,surf} (k) represents the lithium concentration on the surface of the electrode active material at the previous moment, jₙ(k+1) represents the reaction current intensity at the current moment, θ(k+1) represents the parameter vector at the current moment, Δt represents the sampling interval, C_{s,surf} (k+1) represents the lithium concentration on the surface of the electrode active material at the current moment, ƒ_{surf} represents an update function of the lithium concentration on the surface of the electrode active material, c_{s,av}(k) represents the average lithium concentration of the electrode active material at the previous moment, c_{s,surf} (k) represents the lithium concentration on the surface of the electrode active material at the previous moment, jₙ(k+1) represents the reaction current intensity at the current moment, θ(k+1) represents the parameter vector at the current moment, and Δt represents the sampling interval;
update the lithium concentration of the electrode electrolyte at the current moment based on the lithium concentration of the electrode electrolyte at the previous moment, the current of the port at the previous moment, the parameter vector at the current moment and the sampling interval:
$${c}_{e} ( k + 1 ) = {f}_{e} ( {c}_{e} ( k ) , I ( k ) , θ ( k + 1 ) , Δ t )$$
where cₑ(k+1) represents the lithium concentration of the electrode electrolyte at the current moment, ƒₑ represents an update function of the lithium concentration of the electrode electrolyte, cₑ(k) represents the lithium concentration of the electrode electrolyte at the previous moment, I(k) represents the current of the port at the previous moment, θ(k+1) represents the parameter vector at the current moment, and Δt represents the sampling interval;
obtain a port voltage V of the battery and a potential difference U in the battery at the current moment based on the lithium concentration of the electrode electrolyte at the current moment, the lithium concentration on the surface of the electrode active material at the current moment, the reaction current intensity at the current moment, the parameter vector at the current moment, the temperature of the battery at the previous moment and the current of the port at the previous moment:
$$V ( k + 1 ) = {f}_{V} ( {c}_{e} ( k + 1 ) , {c}_{s , surf} ( k + 1 ) , {j}_{n} ( k + 1 ) , {T}_{b} ( k ) , I ( k ) , θ ( k + 1 ) ) \\ U ( k + 1 ) = {f}_{U} ( {c}_{e} ( k + 1 ) , {c}_{s , surf} ( k + 1 ) , {j}_{n} ( k + 1 ) , {T}_{b} ( k ) , I ( k ) , θ ( k + 1 ) )$$
where V(k+1) represents the port voltage of the battery at the current moment, ƒᵥ represents an update function of the port voltage of the battery, cₑ(k+1) represents the lithium concentration of the electrode electrolyte at the current moment, c_{s,surf}(k+1) represents the lithium concentration on the surface of the electrode active material at the current moment, jₙ(k+1) represents the reaction current intensity at the current moment, T_{b}(k) represents the temperature of the battery at the previous moment, I(k) represents the current of the port at the previous moment, θ(k+1) represents the parameter vector at the current moment, U(k+1) represents the potential difference in the battery at the current moment, ƒ_{U} represents an update function of the potential difference in the battery, cₑ (k+1) represents the lithium concentration of the electrode electrolyte at the current moment, c_{s,surf}(k+1) represents the lithium concentration on the surface of the electrode active material at the current moment, jₙ(k+1) represents the reaction current intensity at the current moment, T_{b}(k) represents the temperature of the battery at the previous moment, I(k) represents the current of the port at the previous moment, and θ(k+1) represents the parameter vector at the current moment;
obtain the temperature of the battery at the current moment based on the port voltage of the battery at the current moment, the potential difference in the battery at the current moment, the reaction current intensity at the current moment, the parameter vector at the current moment, the temperature of the battery at the previous moment, the ambient temperature at the previous moment, the current of the port at the previous moment and the sampling interval:
$${T}_{b} ( k + 1 ) = {f}_{T} ( V ( k + 1 ) , U ( k + 1 ) , {j}_{n} ( k + 1 ) , {T}_{b} ( k ) , {T}_{amb} ( k ) , I ( k ) , θ ( k + 1 ) , Δ t )$$
where T_{b}(k+1) represents the temperature of the battery at the current moment, ƒ_{T} represents an update function of the temperature of the battery, V(k+1) represents the port voltage of the battery at the current moment, U(k+1) represents the potential difference in the battery at the current moment, jₙ(k+1) represents the reaction current intensity at the current moment, T_{b}(k) represents the temperature of the battery at the previous moment, T_{amb}(k) represents the ambient temperature at the previous moment, I(k) represents the current of the port at the previous moment, θ(k+1) represents the parameter vector at the current moment, and Δt represents the sampling interval;
define the energy conversion efficiency of the battery based on a charged or discharged state of the battery, the port voltage of the battery at the previous moment and the potential difference in the battery at the previous moment:
$$\{ \begin{matrix}η ( k ) = \frac{V ( k )}{U ( k )} , I ( k ) \geq 0 \\ η ( k ) = \frac{U ( k )}{V ( k )} , I ( k ) < 0\end{matrix}$$
where η(k) represents the energy conversion efficiency of the battery in the discharged state in a case where I(k)≥0, and η(k) represents the energy conversion efficiency of the battery in the charged state in a case where I(k)<0;
repeat the above-mentioned simulation, iteration and update steps, and cyclically updating a state value at the current moment from a state value at the previous moment: the parameter vector, the reaction current intensity, the potential difference on the surface of the electrode, the lithium concentration of the electrode active material, and the lithium concentration of the electrode electrolyte, and outputting the port voltage and the energy conversion efficiency of the battery based on a state update result until the preset time period ends to obtain the simulation result of the battery at each moment within the preset time period, wherein the simulation result of the battery comprises: the port voltage of the battery, the average lithium concentration of the electrode active material, the energy conversion efficiency, and the potential difference on the surface of the electrode, and
wherein the simulation result of the battery is represented as:
$$[ V , {C}_{s} , η , {Φ}_{se} ] = {f}_{bat} ( {SOC}_{0} , {T}_{amb} , I )$$
where V represents the port voltage of the battery at each moment within the preset time period, Cₛ represents the average lithium concentration of the electrode active material at each moment within the preset time period, η represents the energy conversion efficiency at each moment within the preset time period, Φₛₑ represents the potential difference on the surface of the electrode at each moment within the preset time period, f_{bat} represents a set of state update functions, SOC₀ represents the initial state of charge, T_{amb} represents the ambient temperature of the battery, and I represents the amplitude of the constant current sequence of the port.

17. The electronic device of claim 14, wherein the processor is configured to:
set the constraints within the preset time period, defining an inequality error for the constraints, and calculate a Sigmoid function value corresponding to the constraints based on the inequality error to obtain a Sigmoid penalty term corresponding to the constraints, wherein the Sigmoid penalty term approaches 0 in a case where an inequality is established, and the Sigmoid penalty term is a certain larger value in a case where the inequality is not established;
wherein calculating the Sigmoid function value is represented as:
$${f}_{sig} = \frac{{M}_{1}}{1 + exp ( - {M}_{2} * E )}$$
where ƒ_{sig} represents a Sigmoid function, M₁ and M₂ each represent any larger constants, E represents the inequality error, and exp represents an exponential function with a natural constant e as a base;
perform iterative optimization to obtain the maximum feasible current value of the port of the battery satisfying the constraints within the preset time period, comprising:
represent a constrained optimization problem as an unconstrained optimization problem by substituting the Sigmoid penalty term corresponding to the constraints during charging or discharging,
wherein the unconstrained optimization problem during the discharging is represented as:
$${min}_{I} ( - I +$$
$${f}_{V , min} + {f}_{V , max} + {f}_{{cs}^{-} , min} + {f}_{{cs}^{-} , max} + {f}_{{cs}^{+} , min} + {f}_{{cs}^{+} , max} + {f}_{η , min} + {f}_{ϕ , min} )$$
the unconstrained optimization problem during the charging is represented as:
$${min}_{I} ( I +$$
$${f}_{V , min} + {f}_{V , max} + {f}_{{cs}^{-} , min} + {f}_{{cs}^{-} , max} + {f}_{{cs}^{+} , min} + {f}_{{cs}^{+} , max} + {f}_{η , min} + {f}_{ϕ , min} )$$
where ƒ_{V,min}, ƒ_{V,max}, ƒ_{cs}_{^{−}}_{,min}, ƒ_{cs}_{^{−}}_{,max}, ƒ_{cs}_{⁺}_{,min}, ƒ_{cs}_{⁺}_{,max}, ƒ_{η,min} and ƒ_{ϕ,min} are the Sigmoid penalty terms corresponding to the constraints, I represents the amplitude of the current sequence, and min represents a minimum function, and
wherein a process of the iterative optimization is solved via an optimization solver by calling an interior point process.

18. The electronic device of claim 14, wherein the processor is configured to:
perform the simulation by taking the maximum feasible current value during the charging or discharging as the amplitude of the constant current sequence of the input port of the battery based on the ambient temperature and the initial state of charge of the battery, to obtain the curve of the port voltage of the battery during the charging or discharging within the preset time period;
obtain an average port voltage during the charging or discharging based on the curve of the port voltage of the battery during the charging or discharging, calculate the maximum output power of the battery during the charging or discharging based on the average port voltage during the charging or discharging and the amplitude of the constant current sequence during the charging or discharging, and obtain the feasible output power value during the charging or discharging corresponding to the ambient temperature and the initial state of charge of the battery, wherein:
the simulations during the charging and discharging are respectively represented as:
$$[ {V}_{dis} , {C}_{s} , η , {Φ}_{se} ] = {f}_{bat} ( {SOC}_{0} , {T}_{amb} , {I}_{max} ) \\ [ {V}_{char} , {C}_{s} , η , {Φ}_{se} ] = {f}_{bat} ( {SOC}_{0} , {T}_{amb} , {I}_{min} )$$
where V_{dis} represents the curve of the port voltage of the battery during the discharging, V_{char} represents the curve of the port voltage of the battery during the charging, Cₛ represents the average lithium concentration of the electrode active material at each moment within the preset time period, η represents the energy conversion efficiency at each moment within the preset time period, Φₛₑ represents the potential difference on the surface of the electrode at each moment within the preset time period, f_{bat} represents the set of state update functions, SOC₀ represents the initial state of charge, T_{amb} represents the ambient temperature of the battery, Iₘₐₓ represents the maximum feasible current value during the discharging, and Iₘᵢₙ represents the maximum feasible current value during the charging;
the average port voltages during the charging and discharging are respectively represented as:
$${\overline{V}}_{dis} = \frac{{V}_{{dis}_{1}} + {V}_{{dis}_{2}} + … + {V}_{{dis}_{k}} + … {V}_{{dis}_{N}}}{N} \\ {\overline{V}}_{char} = \frac{{V}_{{char}_{1}} + {V}_{{char}_{2}} + … + {V}_{{char}_{k}} + … {V}_{{char}_{N}}}{N}$$
where V̅_{dis} represents the average port voltage during the discharging, V̅_{char} represents the average port voltage during the charging, and N represents a length of the preset time period;
the feasible output power values during the charging and discharging corresponding to the ambient temperature and the initial state of charge of the battery are respectively represented as:
$${P}_{dis} ( {SOC}_{0} , {T}_{amb} ) = {I}_{max} ( {SOC}_{0} , {T}_{amb} ) \times {\overline{V}}_{dis} \\ {P}_{char} ( {SOC}_{0} , {T}_{amb} ) = {I}_{min} ( {SOC}_{0} , {T}_{amb} ) \times {\overline{V}}_{char}$$
where P_{dis}(SOC₀, T_{amb}) represents the feasible output power value corresponding to the ambient temperature and the initial state of charge of the battery during the discharging, P_{char}(SOC₀, T_{amb}) represents the feasible output power value corresponding to the ambient temperature and the initial state of charge of the battery during the charging, Iₘₐₓ(SOC₀, T_{amb}) represents the maximum feasible current value corresponding to the ambient temperature and the initial state of charge of the battery during the discharging, Iₘᵢₙ(SOC₀, T_{amb}) represents the maximum feasible current value corresponding to the ambient temperature and the initial state of charge of the battery during the charging, V̅_{dis} represents the average port voltage during the discharging, and V̅_{char} represents the average port voltage during the charging.

19. The electronic device of claim 14, wherein the processor is configured to:
adjust the ambient temperature T_{amb} and the initial state of charge SOC₀ of the battery, and repeat the above steps to obtain the maximum available power value of the lithium-ion battery during the charging or discharging corresponding to different ambient temperatures and different initial states of charge of the battery, to form a curve of the state of power;
wherein the curve of the state of power is represented as:
$${P}_{char} ( {SOC}_{0} , {T}_{amb} ) \leq P ( {SOC}_{0} , {T}_{amb} ) \leq {P}_{dis} ( {SOC}_{0} , {T}_{amb} )$$
where P_{dis}(SOC₀, T_{amb}) represents the feasible output power value corresponding to the ambient temperature and the initial state of charge of the battery during the discharging, P_{char}(SOC₀, T_{amb}) represents the feasible output power value corresponding to the ambient temperature and the initial state of charge of the battery during the charging, and P(SOC₀, T_{amb}) represents an actual power value of the battery.

20. The electronic device of claim 14, wherein the processor is further configured to:
perform an approximate fitting processing on the state of power by using a piecewise linearization process in an engineering application.
